(19) United States
(12) Patent Application Publication
(10) Pub. No.: US 2011/0245133 A1
(43) Pub. Date: Oct. 6, 2011

(54) COMPOSITION COMPRISING POLYOXYALKYLENE-BASED POLYMER COMPOSITION

(76) Inventors: Jeffrey Scott Dupont, Cincinnati, OH (US); Atsuro Yoneda, Osaka (JP); Daisuke Michitaka, Osaka (JP); Yuki Taguchi, Osaka (JP)

(21) Appl. No.: 13/061,526

(22) PCT Filed: Sep. 1, 2009
(86) PCT No.: PCT/JP2009/065559

§ 371 Date: Jun. 23, 2011

(30) Foreign Application Priority Data
Sep. 1, 2008 (JP) 2008-223317

(51) Int. Cl. C11D 3/37; C08F 216/16; C08F 218/16; C08F 220/06; C08F 218/12; C11D 3/60

(52) U.S. Cl. 510/357; 526/313; 526/318; 526/318.3; 510/360; 510/475; 510/445

(57) ABSTRACT

[Purpose] The purpose of the present invention is to produce a polymer composition with an improved dispersibility for lime soap when used as a detergent and to provide a method for production of the same.

[Means of Solution] A laundry detergent or cleaning composition which comprises a polymer composition containing a polymer obtained by polymerizing a polyoxyalkylene-based compound and an unsaturated monomer containing an acid group in the presence of a polymerization initiator, which is characterized by that the polyoxyalkylene-based compound includes 1) a group containing a carbon-carbon double bond, 2) a polyalkylene glycol chain, and 3) one of the groups shown in formulas (1)-(5), and the amount of solvent used at the time of the polymerization is 10 parts or less for 100 parts of the polyoxyalkylene-based compound.

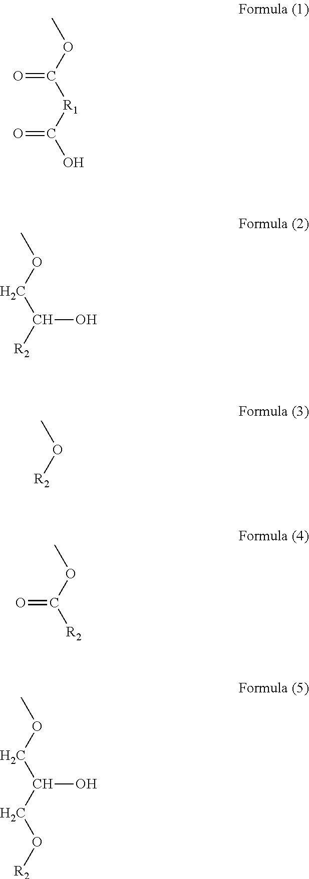

### TECHNICAL FIELD

The present invention pertains to a polyoxyalkylene-based polymer composition and to a method for production of same. The present invention further pertains to a polyoxyalkylene-based polymer composition polymerized without a solvent or in the presence of a small amount of the solvent, and to a method for production of same.

### BACKGROUND ART

In the past, detergent builders (detergent coagents) such as zeolite, carboxymethyl cellulose and polyethylene glycol are commonly blended with a detergent used for laundering clothes for the purpose of increasing the cleaning effect of the detergent.

Furthermore, in addition to the aforementioned variety of detergent builders, polymers are being mixed with the detergent composition as detergent builders in recent years.

For example, use of polyalkylene glycol-based polymers having a hydrophobic part based on glycidyl ether either inside the chain and/or the end, a polymeric double bond having a monomer unit-based on a polyalkylene glycol-based monomer-based on isoprenol, allyl alcohol or methacryl alcohol and a carboxylic acid group and/or sulfonic acid group as a detergent builder is disclosed (for reference, see Patent Reference No. 1). Patent Reference No. 1 discloses that the aforementioned polymer is capable of preventing deposition of the surfactant and/or capable of preventing redeposition of the soil during the course of washing (blocking of resoiling).

With the increase in awareness of environmental problems by consumers, a new attitude toward laundry by consumers where the left-over water after taking a bath is re-used for laundry to conserve water is becoming a common practice. Along with the aforementioned trend, the demand for the performance of detergent builders is changing as well.

That is, the left-over bath water includes soaps used for washing the face and body. Furthermore, the soap forms a bond with calcium in the tap water, etc., and forms a substance referred to as lime soap, and when the soap is deposited onto fibers, etc., yellowing of the fibers may occur or becomes a cause of offensive odors. Furthermore, deposition of the lime soap inside the washing machine becomes a cause of clogging of pipes.

Use of dispersing agents for lime soap has been proposed in the past, and a certain degree of improvement has been observed, but a satisfactory result has not been achieved (Patent Reference Nos. 3-6).

Furthermore, the demand for detergent additives having multiple purposes for a single component and that are capable of achieving multiple of purposes with a lower amount used are on the increase along with smaller packages of the detergent composition.

### CITATION LIST

[Patent Literature]
[PTL1] WO 2007/037469
[PTL2] Japanese Patent Publication (kokai) No. Hei 5-117697
[PTL3] Japanese Patent Publication (kokai) No. Hei 11-511780
[PTL4] Japanese Patent Publication (kokai) No. 2002-201498
[PTL5] Japanese Patent Publication (kokai) No. 2002-201498
[PTL6] Japanese Patent Publication (kokai) No. Hei 1-185398

### SUMMARY OF THE INVENTION

### Technical Problem

As explained above, a variety of detergent compositions have been reported in the past, however, the demand for a detergent capable of dispersing soil, especially, lime soap, on clothes, etc. under harsh washing conditions such as is the case when left-over water from baths is used and that prevents yellowing of the clothes as a result of deposition of the lime soap on the fibers remains strong. However, a detergent capable of adequately satisfying the aforementioned performance requirements has not existed until now. Therefore, the present invention is based on the above background, and the purpose of the present invention is to provide a polyalkylene glycol-based copolymer having excellent dispersibility of lime soap and that can be added successfully to a detergent composition. A different purpose of the present invention is to provide a method for production of the aforementioned polyalkylene glycol-based copolymer with high efficiency.

### Solution Problem

Much research has been done by the inventors of the present application in an effort to eliminate the aforementioned existing problems. As a result, the inventors of the present application discovered that an increase in the dispersibility of lime soap in the polymer composition obtained could be achieved when a polymerization reaction was performed for a specific polyoxyalkylene-based compound and a monomer containing an acid group under specific conditions, and as a result, the present invention was accomplished.

Thus, the polymer composition in the present invention is a polymer composition containing a polymer obtained by polymerizing a polyoxyalkylene-based compound and an unsaturated monomer containing an acid group in the presence of a polymerization initiator, and the polymer composition is characterized by that the polyoxyalkylene-based compound includes

1) a group containing a carbon-carbon double bond,
2) a polyalkylene glycol chain, and
3) one of the groups shown in formulas (1)-(5),

and the amount of solvent used at the time of the polymerization is 10 parts or less for 100 parts of polyoxyalkylene-based compound.

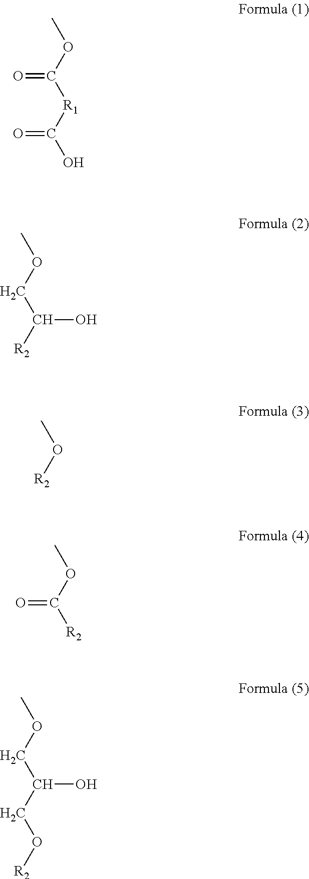

In the aforementioned formula (1), R₁ is an alkylene group with 8-20 carbon atoms or an aromatic group with 6-20 carbon atoms, and in the aforementioned formulas (2)-(5), R₂ is an aryl group with 6-20 carbon atoms or alkyl group with 8-20 carbon atoms or an alkenyl group with 8-20 carbon atoms.

### Advantageous Effects of Invention

The polyalkylene glycol-based copolymer of the present invention displays excellent dispersibility of lime soaps and when used as a detergent builder, yellowing of the fiber or becoming a cause of offensive odors as a result of deposition of the lime soaps onto the laundery can be prevented.

### DESCRIPTION OF EMBODIMENTS

The present invention is explained in further detail below.

The polymer copolymer of the present invention is a polymer composition containing a polymer obtained by polymerizing a specific polyoxyalkylene-based compound and an unsaturated monomer containing an acid group under a specific polymerization reaction condition.

### [Polyoxyalkylene-Based Compound]

The polyoxyalkylene-based compound of the present invention is characterized by containing

1) a group containing a carbon-carbon double bond,
2) polyalkylene glycol chain, and
3) one of the groups shown in the above-mentioned formulas (1)-(5).

For the carbon-carbon double bond included in the polyoxyalkylene-based compound of the present invention is not especially limited and a group containing a carbon-carbon double bond may be used, and groups represented by formula (7) below or formula (8) below are desirable. In this case, the group represented by formula (8) below is especially desirable.

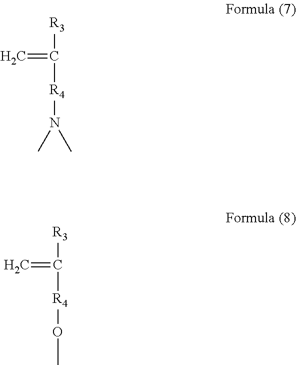

In the aforementioned formulas (7)-(8), R₃ is H or an alkyl group with 1-2 carbon atoms and R₄ is an alkylene group with 1-7 carbon atoms. The carbon-carbon double bond included in the polyoxyalkylene-based compound of the present invention is 2 moles or less per 1 mole of the polyoxyalkylene-based compound. It is further desirable when 1.5 moles or less and 1.2 moles or less is especially desirable. When the value is inside the aforementioned range, an increase in dispersibility of the lime soap-based on the polyoxyalkylene-based polymer is likely to occur.

The content of the structure-based oxyalkylene group (adduct molar number of oxyalkylene group) per 1 mole of the polyoxyalkylene-based compound of the present invention is in the range of 10-100 moles. It is desirable when the content of the structure-based oxyalkylene group per 1 mole of the polyoxyalkylene-based compound is inside the aforementioned range since an increase in the dispersibility of the lime soap is made possible. Furthermore, it is desirable the polyoxyalkylene-based compound includes one or two, preferably one polyalkylene glycol chain having 10-80 of the structure based on the oxyalkylene group.

For the aforementioned oxyalkylene group, 2-20 carbon atoms, preferably, 2-15, preferably, 2-10, especially 2-5, and especially 2-3 and ideally, 2 is desirable. For oxyalkylene group, groups-based on compounds such as ethylene oxide (EO), propylene oxide (PO), isobutylene oxide, 1-butene oxide, 2-butene oxide, trimethyl ethylene oxide, tetramethylene oxide, tetramethyl ethylene oxide, butadiene monoxide, octylene oxide, styrene oxide and 1,1-diphenyl ethylene oxide can be mentioned. Among those listed above, oxyalkylene groups based on EO or PO groups (that is, oxyethylene groups or oxypropylene groups) are further desirable and oxyethylene group is especially desirable. Furthermore, one type of oxyalkylene group may be used or two or more different types may be included as well.

Furthermore, it is desirable when the polyalkylene glycol chain (group formed of oxyalkylene group) included in the polyoxyalkylene-based compound of the present invention is mainly comprised of an oxyethylene group (—O—CH₂—CH₂—). In this case, the aforementioned phrase “mainly comprised of an oxyethylene group” means the total oxyalkylene group is mainly comprised of oxyethylene groups when two or more oxyalkylene groups are included in the monomer. In this case, a smooth polymerization reaction can be promoted at the time of manufacturing, and at the same time, an increase in solubility and dispersibility of lime soap can be achieved.

In the polyalkylene glycol chain included in the polyoxyalkylene-based compound of the present invention, when the aforementioned phrase “mainly comprised of an oxyethylene group” is expressed by mol % of the oxyethylene group included for 100 mol % of the total oxyalkylene group, 50-100 mol % is desirable. When the ratio of the oxyethylene group included is less than 50 mol %, a reduction in the hydrophilic property of the group formed of oxyalkylene group is likely to occur. A suitable ratio is at least 60 mol %, and preferably at least 70 mol %, and especially, at least 80 mol % and ideally, at least 90 mol %.

The polyoxyalkylene-based compound of the present invention is characterized by containing one of the groups represented by formulas (1)-(5) shown below.

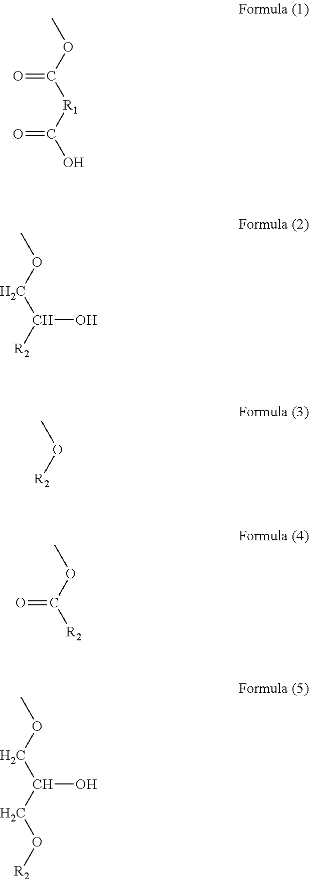

In the aforementioned formula (1), R₁ is an alkylene group with 8-20 carbon atoms or an aromatic group with 6-20 carbon atoms, and in the aforementioned formulas (2)-(5), R₂ is an aryl group with 6-20 carbon atoms or alkyl group with 8-20 carbon atoms an alkenyl group with 8-20 carbon atoms.

The alkylene group, alkyl group or alkenyl group included in the aforementioned formulas (1)-(5) may be linear or branched. In this case, it is suitable when the number of carbon atoms of R₁ or R₂ is in the range of 8-20, preferably, in the range of 10-20, especially, in the range of 11-18 and ideally, in the range of 12-14. When the number of carbon atoms of R₁ or R₂ is below the lower limit of the aforementioned range, interaction with the lime soap is reduced and furthermore, dispersibility is likely to be reduced. On the other hand, when the number of carbon atoms of R₁ or R₂ is 20 or less, a suitable viscosity can be achieved and polymerization reaction can be easily achieved.

In this case, the —O— group included in the aforementioned formulas (1)-(5) can be a part of the aforementioned polyalkylene glycol chain in some cases.

For the —R₁— group in the aforementioned formula (1), namely, for the alkylene group with 8-20 carbon atoms or an aromatic group with 6-20 carbon atoms, compounds listed below can be mentioned.

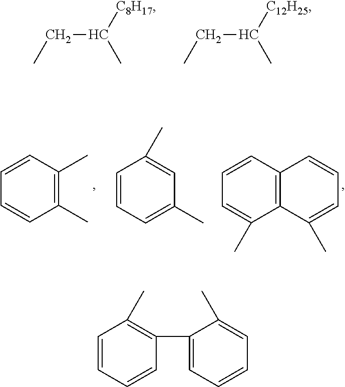

For the alkyl group with 8-20 carbon atoms in the aforementioned formulas (2)-(5), for example, 2-ethyl hexyl group, octyl group, nonyl group, decyl group, undecyl group, dodecyl group, tridecyl group, tetradecyl group, pentadecyl group, hexadecyl group, heptadecyl group, octadecyl group, nonadecyl group and eicocyl group, etc. can be mentioned.

Furthermore, for the alkenyl group with 8 or more carbon atoms included in the aforementioned formulas (2)-(5), for example, octylene group, nonylene group, decylene group, undecylene group, dodecylene group, tridecylene group, tetradecylene group, pentadecylene group, hexadecylene group, heptadecylene group, octadecylene group, nonadecylene group, and eicocylene group, etc. can be mentioned. Among those listed above, it is further desirable when R is a 2-ethylhexyl group, dodecyl group, tridecyl group, tetradecyl group, dodecylene group, tridecylene group or tetradecylene group, and it is especially desirable when 2-ethylhexyl group, dodecyl group, tridecyl group or tetradecyl group.

For the aryl group with 8 or more carbon atoms in the aforementioned formulas (2)-(5), for example, phenetyl group, 2,3- or 2,4-xylyl group, mesityl group, naphthyl group, anthoryl group, phenanthoryl group, biphenylyl group, trityl group, pyrenyl group, etc. can be mentioned. Among those listed above, phenetyl group, 2,3- or 2,4-xylyl group and naphthyl group are further desirable, and phenetyl group, 2,3- or 2,4-xylyl group is especially desirable.

For the compound having the aforementioned formula (1), a compound obtained by adducting polycarboxylic acids such as an anhydride of dicarboxylic acid or anhydrides of the same with a compound formed by adding an alkylene oxide to an alcohol having a carbon-carbon double bond such as allyl alcohol and isoprenol can be mentioned.

For the compound having the aforementioned formula (2), a compound obtained by adducting alkylene oxide with a compound formed by adding an ethylene oxide to an alcohol having a carbon-carbon double bond such as allyl alcohol and isoprenol can be mentioned.

For the compound having the aforementioned formula (3), 1) a compound obtained by adducting an alkyl halide with a compound formed by adding an ethylene oxide to an alcohol having a carbon-carbon double bond such as allyl alcohol and isoprenol, 2) a compound obtained by adducting alkylene glycol monoalkyl ether such as alkoxy PEG (polyethylene glycol monoalkyl ether) with (meth)allyl chloride and 3) a compound obtained by adducting alkylene glycol monoalkyl ether such as alkoxy PEG (polyethylene glycol monoalkyl ether) with an epoxy compound having a carbon-carbon double bond such as allyl glycidyl ether (preferably a compound represented by formula (9) below), can be mentioned.

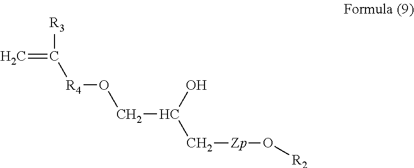

In the aforementioned formula (9), R₂ is an aryl group with 6-20 carbon atoms, alkyl group with 8-20 carbon atoms or alkenyl group with 8-20 carbon atoms, R₃ is H or alkyl group with 1-2 carbon atoms, R₄ is a single bond or alkylene group with 1-7 carbon atoms. In the aforementioned formula (9), Z represents a structure-based on an oxyalkylene group with 2-20 carbon atoms and preferably a structure described in the aforementioned “carbon-carbon double bond”. And p is 10-100.

For the compound having the aforementioned formula (4), a compound obtained by adducting 1) an acid anhydride such as acetic anhydride, 2) an acid chloride and 3) a carboxylic acid with the compound obtained by adducting an alkylene oxide with an alcohol having a carbon-carbon double bond such as allyl alcohol and isoprenol can be mentioned. In this case, it is desirable when a reaction is performed in the presence of an acid catalyst such as p-toluene sulfonic acid when an adduction (esterification) of carboxylic acid is performed.

For the compound having the aforementioned formula (5), a compound obtained by adducting an alkyl glycidyl ether having an alkyl group with 8-20 carbon atoms with a compound obtained by adducting an alkylene oxide with an alcohol having a carbon-carbon double bond such as allyl alcohol and isoprenol can be mentioned.

When one of groups selected from the groups of the aforementioned formulas (1)-(5) is included in the polyoxyalkylene-based compound, an esterification of the unsaturated monomer containing an acid group and polyoxyalkylene-based compound can be inhibited during the course of the polymerization reaction even when a polymerization reaction is performed at a high concentration as in the case of the bulk polymerization reaction, and as a result, i) formation of a desired polymer is made possible, and furthermore, ii) an increase in the viscosity during the course of the polymerization reaction can be controlled, and iii) a reduction in properties etc. of the polymer with the passage of time after the polymerization reaction can be prevented as a result of gradual hydrolysis of the ester bond due to moisture.

For the aforementioned polyoxyalkylene-based compound, commercial products may be used when available or may be newly produced. As a means for formation of the polyalkylene glycol chain included in the polyoxyalkylene-based compound, for example, 1) an anionic polymerization reaction in which a hydroxide of an alkaline metal, strong alkali such as alkoxide or alkyl amine is used as a base catalyst, 2) a cationic polymerization reaction in which a halide, mineral acid, acetic acid, etc. of a metal and metalloid is used as a catalyst, and 3) an adduction method in which the aforementioned alkylene oxide is added to hydroxyl group, amino group, etc. using coordinated polymerization reaction, etc. utilizing a combination of an alkoxide of metals such as aluminum, iron and zinc, alkaline earth metal compound and Lewis acid, can be mentioned.

### [Unsaturated Monomer Containing an Acid Group]

The polyoxyalkylene-based polymer of the present invention is obtained by polymerizing the aforementioned polyoxyalkylene-based compound (also referred to as polyoxyalkylene-based monomer) and an unsaturated monomer containing an acid group.

The unsaturated monomer containing an acid group is a monomer containing an acid group. In this case, for the acid group, for example, carboxyl group, sulfonic acid group, phosphonic acid group, etc. can be mentioned. For the aforementioned unsaturated monomer containing an acid group, for example, monomers containing a carboxyl group such as (meth)acrylic acid, maleic acid, fumaric acid, itaconic acid and crotonic acid; monomers containing a sulfonic acid group such as 2-acrylamide-2-methyl propane sulfonic acid, (meth)allyl sulfonic acid, vinyl sulfonic acid, 2-hydroxy-3-allyloxy-1-propane sulfonic acid and 2-hydroxy-3-butene sulfonic acid; monomers containing phosphonic acid such as vinyl phosphonic acid and (meth)allyl phosphonic acid, etc. can be mentioned. Among those listed above, those containing a carboxyl group are further desirable for the unsaturated monomer containing an acid group from the standpoint of high polymerization performance and good handling ease based on weak acidity, and (meth)acrylic acid and maleic acid are further desirable and acrylic acid and maleic acid are especially desirable and acrylic acid is ideal. The aforementioned unsaturated monomer containing an acid group may be used independently or two or more different types of monomers may be mixed and used in combination as well.

Furthermore, in addition to an unsaturated monomer containing an acid group and polyoxyalkylene-based compound, other monomers copolymerizable with the aforementioned unsaturated monomer containing an acid group or polyoxyalkylene-based compound may be further included as well. The other monomers used in this case are not especially limited, and for example, alkyl (meth)acrylates containing a hydroxyl group such as 2-hydroxyethyl(meth)acrylate, 2-hydroxypropyl(meth)acrylate, 3-hydroxypropyl(meth)acrylate, 2-hydroxybutyl(meth)acrylate, 4-hydroxybutyl(meth)acrylate and alpha-hydroxymethylethyl(meth)acrylate; alkyl(meth)acrylates obtained as a result of an esterification treatment of (meth)acrylic acids such as methyl (meth)acrylate, ethyl (meth)acrylate, butyl (meth)acrylate and cyclohexyl (meth)acrylate and an alcohol with 1-18 carbon atoms; acrylates containing an amino group such as dimethylaminoethyl(meth)acrylate and quartered materials of the same; monomers containing an amide group such as (meth)acryl amide, dimethyl acrylamide and isopropyl acrylamide; vinyl esters containing vinyl acetate; alkenes such as ethylene and propylene; aromatic vinyl monomers such as styrene and styrene sulfonic acid; maleimide derivatives such as maleimide, phenyl maleimide, and cyclohexyl maleimide; vinyl monomers containing nitrile group such as (meth)acrylonitrile; vinyl monomers containing an aldehyde group such as (meth)acrolein; alkyl vinyl ethers such as methyl vinyl ether, ethyl vinyl ether, and butyl vinyl ether; vinyl chloride, vinylidene chloride and allyl alcohol; other monomers containing functional groups such as vinyl pyrrolidone; etc. can be mentioned. The aforementioned monomers may be used independently or two or more different types of monomers may be mixed and used in combination as well.

In this case, the mixing ratio of the unsaturated monomer containing an acid group included in the mixture comprised of the polyoxyalkylene-based compound, unsaturated monomer containing an acid group and other monomers is not especially limited, and in order to fully achieve the effect of the present invention, the mixing ratio of the unsaturated monomer containing an acid group for the total amount of the monomer component (total amount of polyoxyalkylene-based compound, unsaturated monomer containing an acid group and other monomers) is in the range of 5-35% by mass, preferably 6-30% by mass, and especially 7-25% by mass and ideally, 8-20% by mass.

It should be noted that when the calculation of the unsaturated monomer containing an acid group for the total amount of the monomer component is performed in the present invention, the calculation is made in terms of the corresponding acid. For example, when sodium acrylate is used, the calculation of the ratio of the mass (% by mass) is made in terms of the acrylic acid used as a corresponding acid. In the same manner, when other monomers described below are used and a neutralizable group such as an amino group is included in the other monomers, the ratio of the monomer component for the total amount is calculated as a neutral type. For example, when a hydrochloride of vinyl amine is used as the other monomer, it is calculated as a vinyl amine of the corresponding amine (non-neutralized form).

### [Polyoxyalkylene-Based Polymer]

As described above, the polyoxyalkylene-based polymer of the present invention is obtained by polymerizing the aforementioned polyoxyalkylene-based compound (also referred to as polyoxyalkylene-based monomer) and an unsaturated monomer containing an acid group. Furthermore, the polyoxyalkylene-based polymer of the present invention is characterized by the fact that 10 parts or less of solvent is used for 100 parts of the polyoxyalkylene-based compound at the time of the polymerization reaction. In this case, 7% by mass is desirable, 5% by mass or less is further desirable, 3% by mass or less is especially desirable and essentially without any solvent is ideal. The aforementioned phrase “essentially without any solvent” means solvent is not added at the time of the polymerization reaction and inclusion of solvents as impurities is allowed. When a polymerization reaction is performed within the aforementioned range, an increase in dispersibility of the polymer obtained with the lime soap can be expected. It is desirable when the amount of the solvent used at the time of the polymerization reaction is set to be as low as possible, and when possible, it is desirable when the polymerization is done without a solvent (bulk polymerization). When additives such as an initiator are added as a solid material, it is desirable when 10 parts or less of solvent is used for 100 parts of polyoxyalkylene-based compound. When a solvent is used, the solvent may be charged to the polymerization system ahead of time, or the initiator may be dissolved in it first, etc. and it may be added to the system during the course of the polymerization reaction. As described above, when an additive such as an initiator is a solid material, it is desirable when the initiator, etc. is first dissolved and then, added to the system during the course of the polymerization reaction.

As described above, the polyoxyalkylene-based polymer of the present invention is characterized by the fact that amount of the solvent used at the time of the polymerization reaction is 10 parts or less for 100 parts of the polyoxyalkylene-based compound, which does not mean the amount of the solvent used is 10 parts or less for 100 parts of the polyoxyalkylene-based compound for the entire duration of the polymerization reaction. In other words, the time period in which 10 parts or less of the solvent is used for 100 parts of the polyoxyalkylene-based compound is required during the course of the polymerization reaction. However, when the unsaturated monomer containing an acid group is added during the course of the polymerization reaction and the polymerization reaction is performed, it is desirable when the amount of the solvent used is 10 parts or less for 100 parts of the polyoxyalkylene-based compound for at least 50% of the time after addition of the unsaturated monomer containing an acid group, preferably, at least 80% of the time after addition of the unsaturated monomer containing an acid group, and especially, for the entire time after addition of the unsaturated monomer containing an acid group.

Furthermore, when the entire unsaturated monomer containing an acid group is added ahead of time and the polymerization initiator is added during the course of the polymerization reaction and polymerization is performed, it is desirable when the amount of the solvent used is 10 parts or less for 100 parts of the polyoxyalkylene-based compound for at least 50% of the time after addition of the unsaturated monomer containing an acid group, preferably, at least 80% of the time after addition of the unsaturated monomer containing an acid group, and especially, for the entire time after addition of the unsaturated monomer containing an acid group.

Furthermore, when the entire unsaturated monomer containing an acid group and the entire polymerization initiator are added ahead of time and the polymerization reaction is performed, it is desirable when the amount of solvent used is 10 parts or less for 100 parts of the polyoxyalkylene-based compound for at least 50% of the time after addition of the unsaturated monomer containing an acid group, preferably, at least 80% of the time after addition of the unsaturated monomer containing an acid group, and especially, for the entire time after addition of the unsaturated monomer containing an acid group after starting the reduction of the unsaturated monomer containing an acid group and change in the concentration of the residual monomer is absent, or entire time until the residual unsaturated monomer containing an acid group is no longer detected.

As explained below, it is desirable when at least part of the unsaturated monomer containing an acid group and the polymerization initiator is added continuously or in batches during the course of the polymerization reaction.

When the amount of solvent used at the time of the polymerization reaction is 10 parts for 100 parts of the polyoxyalkylene-based compound, the dispersibility of the polymer obtained with the lime soap is likely to be reduced.

Especially when water is used as a solvent, an increase in foaming and viscosity are likely to occur during the course of the polymerization reaction and uniform polymerization cannot be achieved, and so it is desirable when the amount used is set to be as low as possible.

For the solvent used in this case, water or known organic solvents can be used, and those having low chain transfer constant of the monomer component to the solvent or those having a boiling point of 70° C. or above and application under normal pressure are desirable. For the aforementioned solvents, for example, alcohols such as isobutyl alcohol, n-butyl alcohol, tert-butyl alcohol, isopropyl alcohol, ethylene glycol, diethylene glycol, glycerol, triethylene glycol, propylene glycol, ethylene glycol monoalkyl ether and propylene glycol monoalkyl ether; diethers such as ethylene glycol dialkyl ether and propylene glycol dialkyl ether; acetic acid-based compounds such as acetic acid, ethyl acetate, propyl acetate, butyl acetate, acetate of ethylene glycol monoalkyl ether and acetate of propylene glycol monoalkyl ether, etc. can be mentioned. The aforementioned solvents may be used independently or two or more different types of solvents may be mixed and used in combination, as well. For the alkyl group included in the aforementioned alcohols and diethers, for example, methyl group, ethyl group, propyl group, butyl group, etc. can be mentioned.

For the polymerization initiator used in this case, use of an azo compound or organic peroxide is desirable from the standpoint of an increase in the dispersibility of the polymer obtained with the lime soap. In this case, the aforementioned phrase “azo compound or organic peroxide” means at least one among azo compounds or organic peroxides. In other words, either or both azo compounds or organic peroxides may be used for the polymerization initiator.

For azo compounds suitable to be used as a polymerization initiator, for example, dimethyl-2,2′-azobis(2-methyl propionate), 2,2′-azobis(isobutylonitrile), 2,2′-azobis(2-methyl butylonitrile), 2,2′-azobis(2,4-dimethyl valeronitrile), 2,2′-azobis(4-methoxy-2,4-dimethyl valeronitrile), 2,2′-azobisdimethyl(isobutyric acid), 4,4′-azobis(4-cyano valeric acid), 2,2′-azobis(2-methylpropion-amidine) dihydrocholate, 2,2′-azobis[N-(2-carboxy ethyl)-2-methyl propion amidine] n hydrate, 2,2′-azobis[2-(2-imidazoline-2-yl) propane dihydrocholate, 2,2′-azobis[2-(2-imidazoline-2-yl) disulfate dihydrate, 2,2′-azobis(cyclohexane-1-carbonitrile), etc. can be mentioned. The aforementioned azo compounds may be used independently or two or more different types of compounds may be mixed and used in combination as well. Among the aforementioned azo compounds, dimethyl-2,2′-azobis(2-methylpropionate) is especially desirable.

For organic peroxide suitable to be used as a polymerization initiator, for example, benzoyl peroxide, dicumyl peroxide, 2,5-dimethyl-2,5-di(t-butylperoxy)hexane, 1,1′-di-t-butylperoxy-3,3,5-trimethylene cyclohexane, 2,3-di-(t-butyl peroxy)-diisopropyl benzene, di-t-butylperoxide, t-butylhydroperoxide, t-butylperoxy-2-ethylhexanoate, t-butylperoxypivalate, t-amylperoxy-2-ethyl hexanoate, t-amylhydroperoxide, b-butylperoxybenzoate, t-butyl peroxide isopropyl monocarbonate, n-butyl 4,4′-di(t-butylperoxy)valate, etc. can be mentioned. The aforementioned organic peroxides may be used independently or two or more different types may be mixed and used in combination, as well. Among the aforementioned peroxides, t-butylperoxybenzoate (abbreviation PBZ), t-butylperoxyisopropyl monocarbonate (abbreviation PBI) and n-butyl 4,4′-di(t-butylperoxy) valate (abbreviation PHV) are further desirable.

The amount of the polymerization initiator used for the polymerization reaction is appropriately adjusted according to the amount of the monomer component used and it is not especially limited, and for example, an amount in the range of 0.001 parts by mass to 20 parts by mass, preferably, in the range of 0.01 parts by mass to 15 parts by mass, and especially, in the range of 1 parts by mass to 10 parts by mass. In addition to the aforementioned polymerization initiators, a given chain transfer agents, pH modifiers, buffer agents, etc. may be further included, as needed.

Furthermore, a desirable method used for production of the polyoxyalkylene-based polymer of the present invention is as explained under the heading [Manufacturing Method] below.

The weight average molecular weight of the polyoxyalkylene-based polymer of the present invention is appropriately determined taking factors such as desired performance of the detergent builder, etc. into consideration, and is not especially limited, and in specific terms, a desirable weight average molecular weight of the polyoxyalkylene-based polymer of the present invention is in the range of 300-100000, and preferably, in the range of 500-50000 and especially in the range of 1000-30000. When the value of the aforementioned weight average molecular weight is too high, the viscosity is increased and handling is made difficult. On the other hand, when the value of the aforementioned weight average molecular weight is too low, dispersibility of the lime soap is reduced and a sufficient performance of the detergent builder cannot be expected. It should be noted that the value of the weight average molecular weight of the polyoxyalkylene-based polymer of the present invention is-based on the value measured by the method explained in the working example below.

Furthermore, the number average molecular weight of the polyoxyalkylene-based polymer of the present invention is appropriately determined taking factors such as desired performance of the detergent builder, etc. into consideration, and is not especially limited, and in specific terms, a desirable number average molecular weight of the polyoxyalkylene-based polymer of the present invention is in the range of 300-50000, and preferably, in the range of 400-25000 and especially in the range of 500-15000. When the value of the aforementioned number average molecular weight is too high, the viscosity is increased and handling is made difficult. On the other hand, when the value of the aforementioned number average molecular weight is too low, dispersibility of the lime soap is reduced and a sufficient performance of the detergent builder cannot be expected. It should be noted that the value of the number average molecular weight of the polyoxyalkylene-based polymer of the present invention is based on the value measured by the method explained in the working example below.

### [Polymer Composition]

It is essential for the polymer composition of the present invention to include a polyoxyalkylene-based polymer. Furthermore, a non-reacting polyoxyalkylene-based compound, a non-reacting unsaturated monomer containing an acid group, a non-reacting polymerization initiator, a polymerization initiator decomposing agent, a polymer comprised of an unsaturated monomer containing an acid group, etc. may be included as well.

The content of the non-reacting polyoxyalkylene-based compound included in the polymer composition of the present invention is preferably 30% by mass or less for 100% by mass of the solid parts of the polymer composition. In this case, 20% by mass or less is especially desirable. The content of the polymer made of an unsaturated monomer containing an acid group included in the polymer composition of the present invention is preferably 2% by mass or less for 100% by mass of the solid parts of the polymer composition. In this case, 1% by mass or less is further desirable. The content of the non-reacting polyoxyalkylene-based compound is preferably 1000 ppm mass or less for 100% by mass of the solid parts of the polymer composition, and 100 ppm mass or less is especially desirable, and 0 ppm mass or less is especially desirable.

It should be noted that the production of the polymer composition of the present invention is not especially limited and from the standpoint of production efficiency, production is done without a purification process for removal of impurities, etc. Furthermore, a polymer composition diluted with a small amount of water after the polymerization reaction process to improve handling ease (approximately 1-400% by mass for the mixture obtained) is included in the polymer composition of the present invention as well.

### [Manufacturing Method]

The polyoxyalkylene-based polymer of the present invention is manufactured efficiently according to the method explained in detail under the heading [Polyoxyalkylene-based polymer]. Other conditions suitable to be used in the manufacturing method of the present invention are explained in detail below.

Conventional knowledge concerning solid polymerization reactions (bulk polymerization) can be used in the manufacturing method of the present invention and further improvements may be made, as needed.

In addition to the aforementioned polymerization initiator, a decomposition catalyst for the polymerization initiator or reduction compound may be added to the reaction system during the course of the polymerization reaction. For the decomposition catalyst of the polymerization initiator used in this case, for example, metal halides such as lithium chloride and lithium bromide; metal oxides such as titanium oxide and silicon dioxide; metal salts of inorganic acids such as hydrochloric acid, hydrobromic acid, perchloric acid, sulfuric acid and nitric acid; carboxylic acids such as formic acid, acetic acid, propionic acid, lactic acid, isolactic acid, and benzoic acid and esters and metal salts of the same; heterocyclic amines such as pyridine, indole, imidazole and carbazole and derivatives of the same, etc. can be mentioned. The aforementioned decomposition catalysts may be used independently or two or more different types of the same one may be mixed and used in combination, as well.

Furthermore, for the reduction compound, for example, organic metal compounds such as ferrocene, inorganic compounds capable of forming a metal ion such as iron, copper, nickel, cobalt and manganese and that form compounds such as iron naphthenate, copper naphthenate, nickel naphthenate, cobalt naphthenate, and manganese naphthenate; inorganic compounds such as trifluoroboron ether adduct, potassium permanganate and perchloric acid; sulfur containing compounds such as sulfur dioxide, sulfurous acid, sulfate, bisulfite, thiosulfate, sulfoxynate, benzene sulfinic acid and substituents of the same, homologs of cyclic sulfinic acid such as paratoluene sulfinic acid; mercapto compounds such as octyl mercaptane, dodecyl mercaptane, mercapto ethanol, alfa-mercapto propionic acid, thioglycolic acid, thiopropionic acid, alfa-thiopropionic acid sodium sulfopropyl ester and alfa-thiopropionic acid sodium sulfoethyl ester; nitrogen-containing compounds such as hydrazine, beta-hydroxyethyl hydrazine and hydroxylamine; aldehydes such as formaldehyde, acetaldehyde, propionaldehyde, n-butyl aldehyde, isobutyl aldehyde and isovaleraldehyde; ascorbic acid, etc. can be mentioned. Furthermore, aforementioned reduction compounds may be used independently or two or more different types of compounds may be mixed and used in combination, as well. Furthermore, reduction compounds such as mercapto compounds may be added as chain transfer agents as well.

When an azo compound is used as a polymerization initiator, in general, the temperature used at the time of the polymerization reaction is in the range of 40° C. to 120° C., and in the range of 60-110° C. is further desirable, and in the range of 80-100° C. is especially desirable. When an organic peroxide is used as a polymerization initiator, in general, the temperature used at the time of the polymerization reaction is in the range of 100° C. to 200° C., and in the range of 110-180° C. is further desirable, and in the range of 120-150° C. is especially desirable, and furthermore, in the range of 130-140° C. is ideal. When the temperature used at the time of the polymerization reaction is within the aforementioned ranges, the ratio of the residual monomer components is reduced and dispersibility of the polymer material with the lime soap is likely to be increased. Furthermore, it is not necessary to retain the temperature used for the polymerization reaction at a constant temperature throughout the polymerization reaction, and for example, the polymerization reaction may be initiated room temperature and the temperature may be increased to the specified temperature at an appropriate temperature increase rate and subsequently, the set temperature may be retained, or the polymerization temperature may be changed (increased or decreased) with time depending on the addition method used for the monomer component or initiator, etc.

In this case, the polymerization reaction time used is not especially limited, and in general, 30-420 minutes, preferably, 45-390 minutes, especially, 60-360 minutes and ideally, 90-240 minutes is suitable. It should be noted that the “polymerization reaction time” in the present invention means the time during which the monomer is being added.

The pressure used inside the reaction system may be normal pressure (air pressure), reduced pressure or increased pressure, and from the standpoint of the molecular weight of the polymer obtained, it is desirable when the polymerization reaction is conducted under normal pressure or under increased pressure after sealing the reaction system. Furthermore, from the standpoint of equipment such as a pressure device, decompression device, pressure resistant reaction vessels and pipe arrangement, it is desirable when the polymerization reaction is conducted under normal pressure (air pressure). As for the atmosphere inside the reaction system, an aerial atmosphere may be used, but an inert atmosphere is especially desirable, and for example, it is desirable when the air inside the reaction system is replaced with an inert gas such as nitrogen gas prior to the initiation of the polymerization reaction.

It is desirable when the polymerization reaction is initiated after charging a part or all of the polyoxyalkylene-based compound to the reaction system. For example, a method consisting of first charging the total amount of the polyoxyalkylene-based compound to the reaction system, increasing the temperature of the reaction system, and subsequently, adding the monomer component and the polymerization initiator individually and promoting the polymerization reaction can be mentioned. When the aforementioned method is used, an adjustment of the molecular weight of the polymer obtained can be easily achieved. In this case, the polymerization reaction may be performed in batch system or continuous system.

### <Detergent Composition>

The polymer composition of the present invention can be successfully added to a detergent composition.

The polymer composition of the present invention includes the aforementioned polyoxyalkylene-based polymer and the amount of the aforementioned polyoxyalkylene-based polymer included in the detergent composition is not especially limited. And in order to achieve superior performance as a detergent builder, in general, the amount of the polyoxyalkylene-based polymer included is in the range of 0.1-20% by mass, preferably in the range of 0.3-15% by mass and especially in the range of 0.5-10% by mass, for the entire amount of the detergent composition.

The copolymers of the present invention may be utilized in laundry detergents or cleaning compositions comprising a surfactant system comprising C₁₀-C₁₅ alkyl benzene sulfonates (LAS) and one or more co-surfactants selected from nonionic, cationic, anionic or mixtures thereof. The selection of co-surfactant may be dependent upon the desired benefit. In one embodiment, the co-surfactant is selected as a nonionic surfactant, preferably C₁₂-C₁₈ alkyl ethoxylates. In another embodiment, the co-surfactant is selected as an anionic surfactant, preferably C₁₀-C₁₈ alkyl alkoxy sulfates (AEₓS) wherein x is from 1-30. In another embodiment the co-surfactant is selected as a cationic surfactant, preferably dimethyl hydroxyethyl lauryl ammonium chloride. If the surfactant system comprises C₁₀-C₁₅ alkyl benzene sulfonates (LAS), the LAS is used at levels ranging from about 9% to about 25%, or from about 13% to about 25%, or from about 15% to about 23% by weight of the composition.

The above-mentioned laundry detergent or cleaning composition preferably comprises from about 1% to about 20% by weight of the hydrophobic group-containing copolymer composition.

The surfactant system may comprise from 0% to about 7%, or from about 0.1% to about 5%, or from about 1% to about 4% by weight of the composition of a co-surfactant selected from a nonionic co-surfactant, cationic co-surfactant, anionic co-surfactant and any mixture thereof.

Non-limiting examples of nonionic co-surfactants include: C₁₂-C₁₈ alkyl ethoxylates, such as, NEODOL® nonionic surfactants from Shell; C₆-C₁₂ alkyl phenol alkoxylates wherein the alkoxylate units are a mixture of ethyleneoxy and propyleneoxy units; C₁₂-C₁₈ alcohol and C₆-C₁₂ alkyl phenol condensates with ethylene oxide/propylene oxide block alkyl polyamine ethoxylates such as PLURONIC® from BASF; C₁₄-C₂₂ mid-chain branched alcohols, BA, as discussed in U.S. Pat. No. 6,150,322; C₁₄-C₂₂ mid-chain branched alkyl alkoxylates, BAEₓ, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado, issued Jan. 26, 1986; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Non-limiting examples of semi-polar nonionic co-surfactants include: water-soluble amine oxides containing one alkyl moiety of from about 10 to about 18 carbon atoms and 2 moieties selected from the group consisting of alkyl moieties and hydroxyalkyl moieties containing from about 1 to about 3 carbon atoms; water-soluble phosphine oxides containing one alkyl moiety of from about 10 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. No. 4,681,704, and U.S. Pat. No. 4,133,779.

Non-limiting examples of cationic co-surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Nonlimiting examples of anionic co-surfactants useful herein include: C₁₀-C₂₀ primary, branched chain and random alkyl sulfates (AS); C₁₀-C₁₈ secondary (2,3) alkyl sulfates; C₁₀-C₁₈ alkyl alkoxy sulfates (AEₓS) wherein x is from 1-30; C₁₀-C₁₈ alkyl alkoxy carboxylates comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

The present invention may also relates to compositions comprising the inventive copolymers and a surfactant system comprising C₈-C₁₈ linear alkyl sulphonate surfactant and a co-surfactant. The compositions can be in any form, namely, in the form of a liquid; a solid such as a powder, granules, agglomerate, paste, tablet, pouches, bar, gel; an emulsion; types delivered in dual-compartment containers; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a consumer; and other homogeneous or multiphase consumer cleaning product forms.

In one embodiment, the cleaning composition of the present invention is a liquid or solid laundry detergent composition. In another embodiment, the cleaning composition of the present invention is a hard surface cleaning composition, preferably wherein the hard surface cleaning composition impregnates a nonwoven substrate. As used herein “impregnate” means that the hard surface cleaning composition is placed in contact with a nonwoven substrate such that at least a portion of the nonwoven substrate is penetrated by the hard surface cleaning composition, preferably the hard surface cleaning composition saturates the nonwoven substrate. The cleaning composition may also be utilized in car care compositions, for cleaning various surfaces such as hard wood, tile, ceramic, plastic, leather, metal, glass. This cleaning composition could be also designed to be used in a personal care and pet care compositions such as shampoo composition, body wash, liquid or solid soap and other cleaning composition in which surfactant comes into contact with free hardness and in all compositions that require hardness tolerant surfactant system, such as oil drilling compositions.

In another embodiment the cleaning composition is a dish cleaning composition, such as liquid hand dishwashing compositions, solid automatic dishwashing compositions, liquid automatic dishwashing compositions, and tab/unit does forms of automatic dishwashing compositions.

Automatic detergent compositions may comprise low foaming nonionic surfactants (LFNIs). LFNI can be present in amounts from about 0.25% to about 4%. LFNIs are most typically used in automatic detergents on account of the improved water-sheeting action (especially from glass) which they confer to the gel automatic detergents. Preferred LFNIs include nonionic alkoxylated surfactants, especially ethoxylates derived from primary alcohols, and blends thereof with more sophisticated surfactants, such as the polyoxypropylene/polyoxyethylene/polyoxypropylene reverse block polymers. The PO/EO/PO polymer-type surfactants are well-known to have foam suppressing or defoaming action, especially in relation to common food soil ingredients such as egg. In a preferred embodiment, the LFNI is an ethoxylated surfactant derived from the reaction of a monohydroxy alcohol or alkylphenol containing from about 8 to about 20 carbon atoms, excluding cyclic carbon atoms, with from about 6 to about 15 moles of ethylene oxide per mole of alcohol or alkyl phenol on an average basis. A particularly preferred LFNI is derived from a straight chain fatty alcohol containing from about 16 to about 20 carbon atoms (C₁₆-C₂₀alcohol), preferably a C₁₈alcohol, condensed with an average of from about 6 to about 15 moles, preferably from about 7 to about 12 moles, and most preferably from about 7 to about 9 moles of ethylene oxide per mole of alcohol. Preferably the ethoxylated nonionic surfactant so derived has a narrow ethoxylate distribution relative to the average.

The LFNI can optionally contain propylene oxide in an amount up to about 15% by weight. Certain of the block polymer surfactant compounds designated PLURONIC® and TETRONIC® by the BASF-Wyandotte Corp., Wyandotte, Mich., are suitable in gel automatic detergents of the invention. LFNIs which may also be used include a C-18 alcohol polyethoxylate, having a degree of ethoxylation of about 8, commercially available as “SLF-18 Poly-tergent” from BASF Corp.

Dish washing compositions may additionally contain a dispersant polymer typically in the range from 0 to about 25%, preferably from about 0.5% to about 20%, more preferably from about 1% to about 7% by weight of the detergent. The dispersant polymer may be ethoxylated cationic diamines or ethoxylated cationic polyamines described in U.S. Pat. No. 4,659,802. Other dispersant polymers suitable for use include co-polymers synthesized from acrylic acid, maleic acid and methacrylic acid such as ACUSOL® 480N supplied by Rohm & Haas and an acrylic-maleic (ratio 80/20) phosphono end group dispersant copolymers sold under the tradename of Acusol 425N (E) available from Rohm &Haas. Polymers containing both carboxylate and sulphonate monomers, such as ALCOSPERSE® polymers (supplied by Alco) are also acceptable dispersant polymers. In one embodiment an ALCOSPERSE® polymer sold under the trade name ALCOSPERSE® 725, is a co-polymer of Styrene and Acrylic Acid with the following structure:

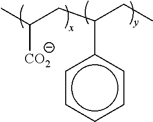

x:y=60:40, or 50:50, MW=8000.

ALCOSPERSE® 725 may also provide a metal corrosion inhibition benefit.

Other dispersant polymers are low molecular weight modified polyacrylate copolymers including the low molecular weight copolymers of unsaturated aliphatic carboxylic acids disclosed in U.S. Pat. Nos. 4,530,766, and 5,084,535 and European Patent Application No. 66,915, published Dec. 15, 1982.

Dish washing compositions may utilize detergent builders to assist in controlling mineral hardness and dispersancy. Inorganic as well as organic builders can be used. Embodiment of such dish washing product can be selected from the group consisting of phosphate, phosphate oligomers or polymers and salts thereof, silicate oligomers or polymers and salts thereof, aluminosilicates, magnesioaluminosiliates, citrate, methyl glycine diacetic acid and/or salts thereof, glutamatic diacetic acid and/or salts thereof and mixtures thereof. Phosphate detergent builders include, but are not limited to, the alkali metal, ammonium and alkanolammonium salts of polyphosphates. Silicate builders herein are any silicates which are soluble to the extent that they do not adversely affect spotting/filming characteristics of the gel detergent composition. Aluminosilicate builders can be used in the present compositions though are not preferred for automatic dishwashing detergents. Carbonate builders include alkaline earth and alkali metal carbonates as disclosed in German Patent Application No. 2,321,001 published on Nov. 15, 1973. Various grades and types of sodium carbonate and sodium sesquicarbonate can be used, certain of which are particularly useful as carriers for other ingredients, especially: detersive surfactants. Organic detergent builders include a wide variety of polycarboxylate compounds. Other useful builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various I alkali metal, ammonium and substituted ammonium salts of polyacetic acids such as ethylenediaminetetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof. Citrate builders, e.g., citric acid and soluble salts thereof (particularly sodium salt), are polycarboxylate builders of particular importance for heavy duty laundry detergent and automatic dishwashing formulations due to their availability from renewable resources and their biodegradability. Methyl glycine diacetic acid and/or salts thereof (MGDA) may also be utilized as builders in the present composition. A preferred MGDA compound is a salt of methyl glycine iacetic acid Suitable salts include the diammonium 1.0 slt, the dipotassium salt and, preferably, the disodium salt. Glutamatic diacetic acid and/or salts thereof (GLDA) may also be utilized as builders in the present compositions. A preferred GLDA compound is a salt of glutamic diacetic acid. Suitable salts include the diammonium salt, the dipotassium salt and, preferably, the disodium salt. 1-hydroxyethylidene-1,1-diphosphonic acid (HEDP) may also be utilized as a builder in the present compositions.

Perfume may be added to the compositions of the present invention. The detergent compositions can contain agents that are effective as corrosion inhibitors and/or anti-tarnish aids.

“Detergent enzyme”, as used herein, means any enzyme having a cleaning, stain removing or otherwise beneficial effect in a gel detergent composition. Preferred enzymes are hydrolases such as proteases, amylases and lipases. Highly preferred for automatic dishwashing are amylases and/or proteases, including both current commercially available types and improved types. Enzyme-containing compositions herein can comprise from about 0.001% to about 10%, preferably from about 0.005% to about 8%, most preferably from about 0.01% to about 6%, by weight of an enzyme.

The compositions herein can also optionally contain one or more transition-metal selective sequestrants, “chelants” or “chelating agents”, e.g., iron and/or copper and/or manganese chelating agents. Chelating agents suitable for use herein can be selected from the group consisting of aminocarboxylates, phosphonates (especially the aminophosphonates), polyfunctionally-substituted aromatic chelating agents, and mixtures thereof. Commercial chelating agents for use herein include the BEQUEST series, and chelants from Monsanto, DuPont, and Nalco, Inc.

The detergent composition can be preferably low foaming, readily soluble in the washing medium and most effective at pH values best conducive to improved cleaning performance, such as in a range of desirably from about pH 6.5 to about pH 12.5, and preferably from about pH 7.0 to about pH 12.0, more preferably from about pH 8.0 to about pH 12.0. The pH adjusting components are desirably selected from sodium or potassium hydroxide, sodium or potassium carbonate or sesquicarbonate, sodium or potassium silicate, boric acid, sodium or potassium bicarbonate, sodium or potassium borate, and mixtures thereof.

An embodiment of the present invention relates to a gel detergent composition comprising an organic solvent selected from the group consisting of low molecular weight aliphatic or aromatic alcohols, low molecular weight alkylene glycols, low molecular weight alkylene glycol ethers, low molecular weight esters, low molecular weight alkylene amines, low molecular weight alkanolamines, and mixtures thereof.

Any adjunct ingredient in any amount may be used in the gel detergent composition. For example, adjunct ingredients may be selected from the group consisting of nanoparticles, functionalized surface molecules, polymers, surfactants, co-surfactants, metal ions, proteins, dyes, acids, optical brighteners, colorants, filler salts, hydrotropes, preservatives, anti-oxidants, germicides, fungicides, color speckles, solubilizing agents, carriers and mixtures thereof.

Quite typically, cleaning compositions herein such as laundry detergents, laundry detergent additives, hard surface cleaners, synthetic and soap-based laundry bars, fabric softeners and fabric treatment liquids, solids and treatment articles of all kinds will require several adjuncts, though certain simply formulated products, such as bleach additives, may require only, for example, an oxygen bleaching agent and a surfactant as described herein. A comprehensive list of suitable laundry or cleaning adjunct materials can be found in WO 99/05242.

Common cleaning adjuncts include builders, enzymes, polymers not discussed above, bleaches, bleach activators, catalytic materials and the like excluding any materials already defined hereinabove. Other cleaning adjuncts herein can include suds boosters, suds suppressors (antifoams) and the like, diverse active ingredients or specialized materials such as dispersant polymers (e.g., from BASF Corp. or Rohm & Haas) other than those described above, color speckles, silvercare, anti-tarnish and/or anti-corrosion agents, dyes, fillers, germicides, alkalinity sources, hydrotropes, anti-oxidants, enzyme stabilizing agents, pro-perfumes, perfumes, solubilizing agents, carriers, processing aids, pigments, and, for liquid formulations, solvents, chelating agents, dye transfer inhibiting agents, dispersants, brighteners, suds suppressors, dyes, structure elasticizing agents, fabric softeners, anti-abrasion agents, hydrotropes, processing aids, and other fabric care agents, surface and skin care agents. Suitable examples of such other cleaning adjuncts and levels of use are found in U.S. Pat. Nos. 5,576,282, 6,306,812 B1 and 6,326,348 B1.

The above-mentioned laundry detergent or cleaning composition preferably contains cleaning adjunct additives selected from the group consisting of enzymes, alkali builders, chelant builders, bleaches, bleaching assisting agents, perfumes, defoaming agents, bactericides, corrosion inhibitors, and mixtures thereof.

### Method of Use

The present invention includes a method for cleaning a targeted surface. As used herein “targeted surface” may include such surfaces such as fabric, dishes, glasses, and other cooking surfaces, hard surfaces, hair or skin. As used herein “hard surface” includes hard surfaces being found in a typical home such as hard wood, tile, ceramic, plastic, leather, metal, glass. Such method includes the steps of contacting the composition comprising the modified polyol compound, in neat form or diluted in wash liquor, with at least a portion of a targeted surface then optionally rinsing the targeted surface. Preferably the targeted surface is subjected to a washing step prior to the aforementioned optional rinsing step. For purposes of the present invention, washing includes, but is not limited to, scrubbing, wiping and mechanical agitation.

As will be appreciated by one skilled in the art, the cleaning compositions of the present invention are ideally suited for use in home care (hard surface cleaning compositions) and/or laundry applications.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

For use in laundry cleaning compositions, the compositions are preferably employed at concentrations from about 200 ppm to about 10000 ppm in solution (or wash liquor). The water temperatures preferably range from about 5° C. to about 60° C. The water to fabric ratio is preferably from about 1:1 to about 20:1.

The method may include the step of contacting a nonwoven substrate impregnated with an embodiment of the composition of the present invention As used herein “nonwoven substrate” can comprise any conventionally fashioned nonwoven sheet or web having suitable basis weight, caliper (thickness), absorbency and strength characteristics. Examples of suitable commercially available nonwoven substrates include those marketed under the tradename SONTARA® by DuPont and POLYWEB® by James River Corp.

As will be appreciated by one skilled in the art, the cleaning compositions of the present invention are ideally suited for use in liquid dish cleaning compositions. The method for using a liquid dish composition of the present invention comprises the steps of contacting soiled dishes with an effective amount, typically from about 0.5 ml. to about 20 ml. (per 25 dishes being treated) of the liquid dish cleaning composition of the present invention diluted in water.

When the aforementioned detergent composition is a liquid detergent composition, in general, the kaolin turbidity is 200 mg/L or less, and in this case, 150 mg/L or less is desirable, 120 mg/L or less is further desirable, 100 mg/L or less is especially desirable and 50 mg/L or less is ideal.

Furthermore, in general, the change (difference) in the turbidity of the kaolin when the polymer composition of the present invention is added or not added to the liquid detergent composition as a detergent builder is 500 mg/L or less, and in this case, 400 mg/L or less is desirable, 300 mg/L or less is further desirable, 200 mg/L or less is especially desirable, and 100 mg/L or less is ideal. In this case, for the value of the turbidity of kaolin, the value obtained by the method explained below is used.

### <Measurement Method for Kaolin Turbidity>

A uniformly stirred sample (liquid detergent) was charged to a square cell of 50 mm² with a thickness of 10 mm, removal of foam was provided, and measurement of the Turbidity (Kaolin turbidity: mg/L) at 25° C. was done using the NDH2000 (product name, turbidity measuring instrument) of Nippon Denshoku Co. Ltd.

The present invention further contains a cleaning implement comprising a nonwoven substrate and the above-mentioned laundry detergent or cleaning composition.

### EXAMPLES

The present invention is explained in further detail with working examples below, but the present invention is not limited by working examples by no means. Furthermore, “parts” represents “parts by mass” and “%” represents “% by mass” unless otherwise specified.

Measurement of the weight average molecular weight and number average molecular weight of the polyoxyalkylene-based polymer of the present invention, deposition inhibition, determination of non-reacting polyoxyalkylene-based compound, determination of compounds 1-3, and furthermore, solid parts of the polymer composition and polymer solution was done according to the methods described below.

### <Mearsurement Conditions for Weight Average Molecular Weight and Number Average Molecular Weight (GPC)>

Device: L-7000 Series, Product of Hitachi Manufacturing Co. Ltd.

### Detector: RI

Column: SHODEX Asahipak GF-310-HQ, GF-710-HQ, GF-1G 7B of Showa Denko Co. Ltd.

### Column Temperature: 40° C.

Flow Velocity: 0.5 mL/min
Analysis Curve: POLYETHYLENE GLYCOL STANDARD of Sowa Kagaku Co. Ltd.
Eluate: 0.1N sodium acetate/acetonitrile=3/1 (mass ratio)

### <Determination of Non-reacting Polyoxyalkylene Compound>

Determination of the non-reacting polyoxyalkylene compound included in the polymer composition was performed by a high-speed chromatography under the condition described below.

### High-Speed Liquid Chromatography

Measuring device: 8020 Series of Toso Co. Ltd.
Column: CAPCELL PAK C1 UG120 of Shiseido Co. Ltd.

### Temperature: 40.0° C.

Eluate: 10 mmol/L disodium hydrogen phosphate 12 hydrate solution (adjusted to pH 7 with phosphic acid)/acetonitrile=45/55 (volume ratio)
Flow Velocity: 1.0 ml/min
Detector: RI, UV (detection wavelength 215 nm)

### <Measuring of Solid Parts of Polymer Composition>

The polymer composition (polymer composition 1.0 g+water 3.0 g) was stored in an oven heated to 130° C. under nitrogen atmosphere for 1 hour, then, drying treatment was performed. Based on the change in the weight before and after the drying treatment, calculation of the solid parts (%) and evaporated component (%) was performed.

### <Measurement of the Amount of Unsaturated Monomer Containing an Acid Group (Acrylic Acid) in Polymer Composition>

Measurement of the amount of acrylic acid was done by a liquid chromatography under the conditions shown in Table 1 below.

Measuring device: L-7000 Series, Product of Hitachi Manufacturing Co. Ltd.
Detector: UV detector L-7400, Product of Hitachi Manufacturing Co. Ltd.
Column: SHODEX RSpak DE-413, Product of Showa Denko Co. Ltd.

### Temperature: 40.0° C.

Eluent: 0.1% phosphic acid solution
Flow Velocity: 1.0 ml/min

### <Measuring of Shrinkage Factor of Polymer (Also Referred to as Polymer Shrinkage Factor)>

It is defined that the content (% by mass) of the copolymer included in the polymer composition (solid parts conversion)=polymer shrinkage factor. That is, the ratio of the mass of the copolymer included in the polymer composition for the mass of the solid parts of the polymer composition, and the calculation was made based on the equation shown below.

Copolymer content (% by mass) in polymer composition (solid parts conversion)=100 (% by mass)−(content of non-reacting polyoxyalkylene compound in polymer composition (% by mass)+content of unsaturated monomer containing an acid group included in the solid parts of the polymer composition (% by mass)+polymer containing unsaturated monomer containing an acid group alone (% by mass))

In this case, determination of the polymer comprised of an unsaturated monomer containing an acid group was done by the capillary electrophoresis measurement method described below.

### <Electrophoresis Measuring Condition>

### Device: Photal OTSUKA ELECTRONICS CAPI-3300 CAPILLARY ELECTROPHORESIS SYSTEM

Column: Product of Otsuka Electronics Co. Ltd. GL Capillary Tube 75 u×50 cm

### Voltage: 15 kV

Development solvent: 50 mmol/L 4-sodium borate solution
Migration time: 30 minutes

### Detection: UV 210 nm

### <Evaluation of Transparency of Polymer Composition>

The transparency of the polymer composition was visually confirmed at 25° C. Those with and absence of phase separation or turbidity are marked with //circle// and those with phase separation or turbidity are marked with x.

### <Evaluation Method for Dispersibility of Lime Soap (Dispersing Performance of Lime Soap)>

(1) Purified water was added to 1.5 g of 1% polymer solution and 7.5 g of 1% sodium oleate solution so as to make 79.5 g.
(2) Then, 0.5 ml of 6% calcium chloride/magnesium chloride (Ca:Mg=3:2 molar ratio) solution (in terms of calcium carbonate) was added to the aforementioned solution and stirring was performed for 30 seconds.
(3) The transmittance of the solution was measured by luminous electrode. For measuring, an automatic titration device of Hiranuma Industry Co. Ltd. (Main unit: COM-550, luminance measuring unit: M-500) was used.

### Synthesis Example of Polyoxyalkylene-Based Compound 1

425.6 g of New-Cole 2320 (Product of Nippon Nyukazai Co. Ltd., C12-13 alcohol with 20 mol adduct of ethylene oxide) and 35.3 g of potassium hydroxide (hereinafter referred to as “KOH” at times.) were charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was performed. Subsequently, a reflux condenser was attached and the temperature was reduced to 60° C., then, 54.0 g of methacryl chloride (hereinafter referred to as “MLC” at times.) was added in 30 minutes, and then, a reaction was performed for 5 hours. Furthermore, 50.0 g of purified water was added and a reaction was performed for 1 hour and sulfuric acid was added to neutralize. The temperature was then reduced to room temperature and the aforementioned aqueous solution was transferred to a pear-shaped flask of 1000 ml and removal of the solvent was performed by a rotary evaporator. Furthermore, ethanol was added and the salt deposited was removed through filtration. The aforementioned desalting process was repeated three times and complete removal of the solvent was achieved to give monomer 1.

### Working Example 1

99.0 g of monomer 1 was charged to a glass separable flask with a capacity of 500 mL and provided with a stirring device (puddle wing), then, the temperature was increased to 120° C. under stirring while injecting nitrogen and the aforementioned conditions was maintained for 1 hour and dehydration of the reaction system was performed. Subsequently, a reflux condenser was attached and the temperature was increased to 135° C.; then, 11.0 g of 100% acrylic acid (hereinafter referred to as “AA” at times.) and 527 μL (0.55 g, mass ratio of 5.0% by mass for AA) of t-butyl peroxide benzoate (hereinafter referred to as “PBZ” at times.), as a polymerization initiator, were added from separate nozzles. The dropwise addition time for the solutions was set for 210 minutes for PBZ and 210 minutes for AA, starting 20 minutes after starting the addition of PBZ. Furthermore, the drop ratio of each solution was constant and addition of each solution was done continuously. After addition of the AA was completed, the aforementioned reaction solution was maintained at a temperature of 135° C. for 70 minutes longer (ageing) to end the polymerization reaction. After the polymerization reaction was completed, 27.6 g of purified water was added to dilute the polymerization reaction solution while stirring and natural cooling was provided for the polymerization reaction solution.

In this manner, an aqueous solution with a weight average molecular weight of 7600 and solid parts concentration (mass) of 80.2% was obtained (polymer composition 1).

### Working Example 2

99.7 g of monomer 1 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was increased to 135° C.; then, 17.6 g of 100% AA and 844 μL (0.88 g, mass ratio of 5.0% by mass for AA) of PBZ, as a polymerization initiator, were added from separate nozzles. The dropwise addition time for the solutions was set for 210 minutes for PBZ and 210 minutes for AA, starting 20 minutes after starting addition of PBZ. Furthermore, the drop ratio of each solution was constant and addition of each solution was done continuously. After the addition of AA was completed, the aforementioned reaction solution was maintained at a temperature of 135° C. for 70 minutes longer (aging) to end the polymerization reaction. After the polymerization reaction was completed, 29.5 g of purified water was added to dilute the polymerization reaction solution while stirring and natural cooling was provided for the polymerization reaction solution.

In this manner, an aqueous solution with a weight average molecular weight of 10000 and solid parts concentration (mass) of 80.5% was obtained (polymer composition 2).

### Synthesis Example of Polyoxyalkylene-Based Compound 2

228.6 g of 50 mol ethylene oxide adduct of isoprenol (Hereinafter referred to as “IPN50” at times.), 20.0 g of laurate and 2.5 g of paratoluene sulfonate (Hereinafter referred to as “PTS” at times.) were charged to a glass separable flask with a capacity of 500 mL and provided with a stirring device (puddle wing); then, the temperature was increased to 120° C. under stirring while injecting nitrogen and the aforementioned condition was maintained for 1 hour and estrification and dehydration of the reaction system were achieved to give monomer 2.

### Working Example 3

99.0 g of monomer 2 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was performed. Subsequently, a reflux condenser was attached and the temperature was increased to 135° C.; then, 11.0 g of 100% AA and 527 μL (0.55 g, mass ratio of 5.0% by mass for AA) of PBZ, as a polymerization initiator, were added from separate nozzles. The dropwise addition time for the solutions was set to 210 minutes for PBZ and 210 minutes for AA, starting 20 minutes after starting addition of PBZ. Furthermore, the drop ratio of each solution was constant and addition of each solution was done continuously. After the addition of AA was completed, the aforementioned reaction solution was maintained at a temperature of 135° C. for 70 minutes longer (aging) to end the polymerization reaction. After the polymerization reaction was completed, 27.6 g of purified water was added to dilute the polymerization reaction solution while stirring and natural cooling was provided for the polymerization reaction solution.

In this manner, an aqueous solution with a weight average molecular weight of 9800 and solid parts concentration (mass) of 80.6% was obtained (polymer composition 3).

### Synthesis Example of polyoxyalkylene-based compound 3

823.0 g of IPN50 and 9.1 g of KOH were charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was reduced to 90° C.; then, 87.1 g of lauryl glycidyl ether (hereinafter referred to as “LGE” at times.) was added in 30 minutes, and then, the reaction was continued for 5 hours. Furthermore, the temperature was reduced to 60° C. and 9.6 g of acetic acid was added so as to neutralize KOH and to give monomer 3.

### Working Example 4

99.0 g of monomer 3 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was increased to 135° C.; then, 11.0 g of 100% AA and 527 μL (0.55 g, mass ratio of 5.0% by mass for AA) of PBZ, as a polymerization initiator, were added from separate nozzles. The dropwise addition time for the solutions was set for 210 minutes for PBZ and 210 minutes for AA, starting 20 minutes after starting the addition of PBZ. Furthermore, the drop ratio of each solution was constant and addition of each solution was done continuously. After the addition of AA was completed, the aforementioned reaction solution was maintained at a temperature of 135° C. for 70 minutes longer (ageing) so as to end the polymerization reaction. After the polymerization reaction was completed, 27.6 g of purified water was added to dilute the polymerization reaction solution while stirring and natural cooling was provided for the polymerization reaction solution.

In this manner, an aqueous solution with a weight average molecular weight of 11000 and solid parts concentration (mass) of 80.5% was obtained (polymer composition 4).

### Synthesis Example of Polyoxyalkylene-Based Compound 4

685.8 g of IPN50 and 7.7 g of KOH were charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was performed. Subsequently, a reflux condenser was attached and the temperature was reduced to 90° C.; then, 83.7 g of 2-ethylhexylglycidyl ether (hereinafter referred to as “EHGE” at times) was added in 30 minutes, and then, the reaction was continued for 5 hours. Furthermore, the temperature was reduced to 60° C. and 8.4 g of acetic acid was added to neutralize the KOH and to give monomer 4.

### Working Example 5

99.0 g of monomer 4 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was performed. Subsequently, a reflux condenser was attached and the temperature was increased to 135° C.; then, 11.0 g of 100% AA and 527 μL (0.55 g, mass ratio of 5.0% by mass for AA) of PBZ, as a polymerization initiator, were added from separate nozzles. The dropwise addition time for each solution was set for 210 minutes for PBZ and 210 minutes for AA, starting 20 minutes after starting the addition of PBZ. Furthermore, the drop ratio for the solutions was constant and addition of each solution was done continuously.

After the addition of AA was completed, the aforementioned reaction solution was maintained at a temperature of 135° C. for 70 minutes longer (aging) to end the polymerization reaction. After the polymerization reaction was completed, 27.6 g of purified water was added to dilute the polymerization reaction solution while stirring and natural cooling was provided for the polymerization reaction solution.

In this manner, an aqueous solution with a weight average molecular weight of 12000 and solid parts concentration (mass) of 80.3% was obtained (polymer composition 5).

### Synthesis Example of Polyoxyalkylene-Based Compound 5

415.1 g of 25 mol ethylene oxide adduct of isoprenol (Hereinafter referred to as “IPN25” at times) and 7.5 g of KOH were charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was performed. Subsequently, a reflux condenser was attached and the temperature was reduced to 90° C.; then, 87.5 g of LGE was added in 30 minutes, and then, the reaction was continued for 5 hours. Furthermore, the temperature was reduced to 60° C. and 8.0 g of acetic acid was added to neutralize KOH and to give monomer 5.

### Working Example 6

99.7 g of monomer 5 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was increased to 135° C.; then, 17.6 g of 100% AA and 844 μL, (0.88 g, mass ratio of 5.0% by mass for AA) of PBZ, as a polymerization initiator, were added from separate nozzles. The dropwise addition time of each solution was set for 210 minutes for PBZ and 210 minutes for AA, starting 20 minutes after starting the addition of PBZ. Furthermore, the drop ratio of each solution was constant and addition of each solution was done continuously. After addition of AA was completed, the aforementioned reaction solution was maintained at a temperature of 135° C. for 70 minutes longer (aging) to end the polymerization reaction. After the polymerization reaction was completed, 29.5 g of purified water was added to dilute the polymerization reaction solution while stirring and natural cooling was provided for the polymerization reaction solution.

In this manner, an aqueous solution with a weight average molecular weight of 3500 and solid parts concentration (mass) of 80.5% was obtained (polymer composition 6).

### Working Example 7

99.7 g of monomer 5 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and 17.6 g of maleic acid (Hereinafter referred to as “MA” at times) was added all at once; then, the temperature was increased to 135° C., and 844 μL (0.88 g, mass ratio of 5.0% by mass for MA) of PBZ, as a polymerization initiator, was added dropwise. The dropwise addition time was set for 210 minutes. Furthermore, the drop ratio was constant and the addition was done continuously. After addition of PBZ was completed, the aforementioned reaction solution was maintained at a temperature of 135° C. for 60 minutes longer (aging) to end the polymerization reaction. After the polymerization reaction was completed, 29.5 g of purified water was added to dilute the polymerization reaction solution while stirring and natural cooling was provided for the polymerization reaction solution.

In this manner, an aqueous solution with a weight average molecular weight of 2800 and solid parts concentration (mass) of 80.1% was obtained (polymer composition 7).

### Working Example 8

92.7 g of monomer 1 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was decreased to 90° C.; then, 10.3 g of 100% AA and 1.72 g (mass ratio of 10.0% by mass for AA) of 60% isopropanol solution of dimethyl 2,2′-azobis(2-methyl propionate) (Hereinafter referred to as “V601” at times), as a polymerization initiator, were added from separate nozzles.

The dropwise addition time for each solution was set at 220 minutes for V601 and 210 minutes for AA, starting 5 minutes after starting the addition of V601. Furthermore, the drop ratio of each solution was constant and addition of each solution was done continuously. After addition of AA was completed, the aforementioned reaction solution was maintained at a temperature of 90° C. for 60 minutes longer (aging) to end the polymerization reaction. After the polymerization reaction was completed, 25.4 g of purified water was added to dilute the polymerization reaction solution while stirring and natural cooling was provided for the polymerization reaction solution.

In this manner, an aqueous solution with a weight average molecular weight of 8600 and solid parts concentration (mass) of 80.5% was obtained (polymer composition 8).

### Working Example 9

87.6 g of monomer 2 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was decreased to 90° C.; then, 15.5 g of 100% AA and 2.58 g (mass ratio of 10.0% by mass for AA) of 60% isopropanol solution of V601, as a polymerization initiator, were added from separate nozzles.

The dropwise addition time of each solution was set for 220 minutes for V601 and 210 minutes for AA, starting 5 minutes after starting the addition of V601. Furthermore, the drop ratio of each solution was constant and addition of each solution was done continuously. After addition of AA was completed, the aforementioned reaction solution was maintained at a temperature of 90° C. for 60 minutes longer (ageing) so as to end the polymerization reaction. After the polymerization reaction was completed, 25.4 g of purified water was added to dilute the polymerization reaction solution while stirring and natural cooling was provided for the polymerization reaction solution.

In this manner, an aqueous solution with a weight average molecular weight of 15000 and solid parts concentration (mass) of 80.4% was obtained (polymer composition 9).

### Working Example 10

87.6 g of monomer 3 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was performed. Subsequently, a reflux condenser was attached and the temperature was decreased to 90° C.; then, 15.5 g of 100% AA and 2.58 g (mass ratio of 10.0% by mass for AA) of 60% isopropanol solution of V601, as a polymerization initiator, were added from separate nozzles.

The dropwise addition time of each solution was set for 220 minutes for V601 and 210 minutes for AA, starting 5 minutes after starting the addition of V601. Furthermore, the drop ratio of each solution was constant and addition of each solution was done continuously. After addition of AA was completed, the aforementioned reaction solution was maintained at a temperature of 90° C. for 60 minutes longer (aging) to end the polymerization reaction. After the polymerization reaction was completed, 25.4 g of purified water was added to dilute the polymerization reaction solution while stirring and natural cooling was provided for the polymerization reaction solution.

In this manner, an aqueous solution with a weight average molecular weight of 14000 and solid parts concentration (mass) of 80.4% was obtained (polymer composition 10).

### Working Example 11

87.6 g of monomer 4 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was decreased to 90° C.; then, 15.5 g of 100% AA and 2.58 g (mass ratio of 10.0% by mass for AA) of 60% isopropanol solution of V601, as a polymerization initiator, were added from separate nozzles.

The dropwise addition time of each solution was set for 220 minutes for V601 and 210 minutes for AA, starting 5 minutes after starting addition of V601. Furthermore, the drop ratio of each solution was constant and addition of each solution was continuously performed. After the addition of AA was completed, the aforementioned reaction solution was maintained at a temperature of 90° C. for 60 minutes longer (aging) to end the polymerization reaction. After the polymerization reaction was completed, 25.4 g of purified water was added to dilute the polymerization reaction solution while stirring and natural cooling was provided for the polymerization reaction solution.

In this manner, an aqueous solution with a weight average molecular weight of 14000 and solid parts concentration (mass) of 80.3% was obtained (polymer composition 11).

### Working Example 12

87.6 g of monomer 5 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was decreased to 90° C.; then, 15.5 g of 100% AA and 2.58 g (mass ratio of 10.0% by mass for AA) of 60% isopropanol solution of V601, as a polymerization initiator, were added from separate nozzles.

The dropwise addition time of each solution was set for 220 minutes for V601 and 210 minutes for AA, starting 5 minutes after starting the addition of V601. Furthermore, the drop ratio of each solution was constant and addition of each solution was done continuously. After addition of AA was completed, the aforementioned reaction solution was maintained at a temperature of 90° C. for 60 minutes longer (aging) to end the polymerization reaction. After the polymerization reaction was completed, 25.4 g of purified water was added to dilute the polymerization reaction solution while stirring and natural cooling was provided for the polymerization reaction solution.

In this manner, an aqueous solution with a weight average molecular weight of 14000 and solid parts concentration (mass) of 80.5% was obtained (polymer composition 12).

### Synthesis Example of Polyoxyalkylene-Based Compound 6

532.0 g of New-Cole 2320 and 3.1 g of KOH were charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was reduced to 90° C.; then, 85.5 g of allyl glycidyl ether (Hereinafter referred to as “AGE” at times) was added in 30 minutes, and then, a reaction was performed for 5 hours. Furthermore, the temperature was reduced to 60° C. and 3.3 g of acetic acid was added to neutralize the KOH and to give monomer 6.

### Working Example 13

87.6 g of monomer 6 was charged to a glass separable flask with a capacity of 500 mL and provided with a stirring device (puddle wing); then, the temperature was increased to 120° C. under stirring while injecting nitrogen and the aforementioned condition was maintained for 1 hour and dehydration of the reaction system was achieved. Subsequently, a reflux condenser was attached and the temperature was decreased to 90° C.; then, 15.5 g of 100% AA and 2.58 g (mass ratio of 10.0% by mass for AA) of 60% isopropanol solution of V601, as a polymerization initiator, were added from separate nozzles. The dropwise addition time of each solution was set for 220 minutes for V601 and 210 minutes for AA, starting 5 minutes after starting the addition of V601. Furthermore, the drop ratio of each solution was constant and addition of each solution was done continuously.

After addition of AA was completed, the aforementioned reaction solution was maintained at a temperature of 90° C. for 60 minutes longer (aging) to end the polymerization reaction. After the polymerization reaction was completed, 25.4 g of purified water was added to dilute the polymerization reaction solution while stirring and natural cooling was provided for the polymerization reaction solution.

In this manner, an aqueous solution with a weight average molecular weight of 19000 and solid parts concentration (mass) of 80.3% was obtained (polymer composition 13).

### Comparative Example 1

61.2 g of monomer 5, 40.8 g of purified water and 0.0041 g of Mohr's salt were charged to a glass separable flask with a capacity of 500 mL and provided with a stirring device (puddle wing); then, the temperature was increased to 90° C. under stirring, and furthermore, 13.5 g of 80% AA, 8.5 g of 15% NaPS, 2.5 g of 35% SBS and 21.8 g of purified water were added from separate nozzles.

The dropwise addition time for the solutions was set for 180 minutes for AA, 180 minutes for 48% NaOH, 210 minutes for 15% NaPS, 175 minutes for 35% SBS and 180 minutes for purified water. In this case, the addition starting time was the same for all. The temperature of 90° C. was maintained until the addition of 80% AA was completed.

The aforementioned temperature was retained for 30 minutes after addition of 80% AA was completed ageing was performed so as to end the polymerization reaction. After the polymerization reaction was completed, natural cooling was provided for the reaction solution; then, 11.3 g of 48% NaOH and 33.3 g of purified water were added to neutralize. In this manner, an aqueous solution with a weight average molecular weight of 4500 and solid parts concentration (mass) of 41.3% was obtained (Comparison polymer composition 1).

In this case, a significant increase in viscosity and foaming was observed during the course of the polymerization reaction. Furthermore, the comparison polymer composition 1 (solid parts conversion) included 65% of residual monomer 5.

### Working Example 14

Finally, evaluation was done for dispersibility of the polymer compositions obtained in the Working Examples and Comparative Example with lime soap according to the aforementioned evaluation methods. And the results obtained are shown in Table 1 below.

TABLE 1

| | | Adduct | Ratio of | | | | | | |
|---|---|---|---|---|---|---|---|---|---|
| | Carbon | molar | polyoxyalkylene-based | | | | | Trans- | |
| | atoms | number of | compound/unsaturated | | | | | parency | |
| | of | oxyalkylene | monomer containing an | | | | | of | |
| | alkyl | group per 1 | acid group included in | Polymer- | | Molecular | Polymer | polymer | |
| | group, | mole | the entire monomer | ization | Solid | weight | yield | compo- | Dispersibility |
| | etc. | monomer | (% by mass) | initiator | parts | (Mw/Mn) | (%) | sition | of lime soap |
| Working Example 1 | 12 | 20 | 90/10 | PBZ | 80.2 | 7600/3200 | 100 | ∘ | 70 |
| Working Example 2 | 12 | 20 | 85/15 | PBZ | 80.5 | 10000/4600 | 100 | ∘ | 75 |
| Working Example 3 | 12 | 50 | 90/10 | PBZ | 80.6 | 9800/3800 | 100 | ∘ | 86 |
| Working Example 4 | 12 | 50 | 90/10 | PBZ | 80.5 | 11000/3400 | 100 | ∘ | 90 |
| Working Example 5 | 8 | 50 | 90/10 | PBZ | 80.3 | 12000/3500 | 100 | ∘ | 83 |
| Working Example 6 | 12 | 25 | 85/15 | PBZ | 80.5 | 3500/1400 | 100 | ∘ | 84 |
| Working Example 7 | 12 | 25 | 85/15 | PBZ | 80.1 | 2800/1500 | 100 | ∘ | 88 |
| Working Example 8 | 12 | 20 | 90/10 | V601 | 80.5 | 8600/3500 | 85 | ∘ | 68 |
| Working Example 9 | 12 | 50 | 85/15 | V601 | 80.4 | 15000/8300 | 100 | ∘ | 88 |
| Working Example 10 | 8 | 50 | 85/15 | V601 | 80.6 | 14000/8800 | 100 | ∘ | 89 |
| Working Example 11 | 8 | 50 | 85/15 | V601 | 80.3 | 14000/8100 | 100 | ∘ | 77 |
| Working Example 12 | 12 | 25 | 85/15 | V601 | 80.5 | 14000/5500 | 96 | ∘ | 84 |
| Working Example 13 | 12 | 20 | 85/15 | V601 | 80.3 | 19000/10000 | 95 | ∘ | 75 |
| Comparative Example 1 | 12 | 25 | 85/15 | NaPS | 41.3 | 4500/1700 | 35 | x | 66 |

As shown in the results in Table 1, in comparison to a polymer composition of the prior art, the polymer compositions of the present invention exhibit superior dispersibility with lime soap.

Therefore, when the polymer composition of the present invention is used as a detergent builder, deposition of the lime soap onto the laundry can be effectively inhibited even when laundry is done using left-over bath water.

Furthermore, in comparison to the polymer composition of the prior art, the polymer composition of the present invention has superior transparency. It is hypothesized that a polymer with a higher uniformity achieved in the present invention in comparison to the prior art is responsible for the aforementioned effect.

### Composition Formulations

### Granular Laundry Detergent Examples 10

| | A | B | C | D | E |
|---|---|---|---|---|---|
| Formula | wt % | wt % | wt % | wt % | wt % |
| C₁₁₋₁₂ Linear alkyl benzene | 13-25 | 13-25 | 13-25 | 13-25 | 9-25 |
| sulphonate | | | | | |
| C₁₂₋₁₈ Ethoxylate Sulfate | — | — | 0-3 | — | 0-1 |
| C₁₄₋₁₅ alkyl ethoxylate (EO = 7) | 0-3 | 0-3 | — | 0-5 | 0-3 |
| Dimethyl hydroxyethyl lauryl | — | — | 0-2 | 0-2 | 0-2 |
| ammonium chloride | | | | | |
| 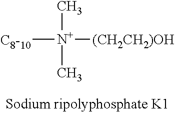 | 20-40 | — | 18-33 | 12-22 | 0-15 |
| Zeolite | 0-10 | 20-40 | 0-3 | — | — |
| Silicate builder | 0-10 | 0-10 | 0-10 | 0-10 | 0-10 |
| Carbonate | 0-30 | 0-30 | 0-30 | 5-25 | 0-20 |
| Diethylene triamine penta acetate | 0-1 | 0-1 | 0-1 | 0-1 | 0-1 |
| Polyacrylate | 0-3 | 0-3 | 0-3 | 0-3 | 0-3 |
| Carboxy Methyl Cellulose | 0.2-0.8 | 0.2-0.8 | 0.2-0.8 | 0.2-0.8 | 0.2-0.8 |
| Copolymer¹ | 1-20 | 1-20 | 5.0 | 10 | 2.5 |
| Percarbonate | 0-10 | 0-10 | 0-10 | 0-10 | 0-10 |
| Nonanoyloxybenzenesulfonate | — | — | 0-2 | 0-2 | 0-2 |
| Tetraacetylethylenediamine | — | — | 0-0.6 | 0-0.6 | 0-0.6 |
| Zinc Phthalocyanine | — | — | 0-0.005 | 0-0.005 | 0-0.005 |
| Tetrasulfonate | | | | | |
| Brightener | 0.05-0.2 | 0.05-0.2 | 0.05-0.2 | 0.05-0.2 | 0.05-0.2 |
| MgSO₄ | — | — | 0-0.5 | 0-0.5 | 0-0.5 |
| Enzymes | 0-0.5 | 0-0.5 | 0-0.5 | 0-0.5 | 0-0.5 |
| Minors (perfume, dyes, suds | balance | balance | balance | balance | balance |
| stabilizers) | | | | | |

¹A copolymer according to any of Application Examples 1, 2, 3, 4, 5, 6, 7, 8, 9 10, 11, 12 or 13.

### Granular Laundry Detergent Example 11

### Aqueous Slurry Composition.

| | % w/w Aqueous |
|---|---|
| Component | slurry |
| A compound having the following general | 1.23 |
| structure: bis((C₂H₅O)(C₂H₄O)n)(CH₃)—N⁺— | |
| CₓH₂ₓ—N⁺—(CH₃)—bis((C₂H₅O)(C₂H₄O)n), | |
| wherein n = from 20 to 30, and x = from 3 to 8, | |
| or sulphated or sulphonated variants thereof | |
| Ethylenediamine disuccinic acid | 0.35 |
| Brightener | 0.12 |
| Magnesium sulphate | 0.72 |
| Acrylate/maleate copolymer | 6.45 |
| Copolymer ¹ | 1.60 |
| Linear alkyl benzene sulphonate | 11.92 |
| Hydroxyethane di(methylene phosphonic acid) | 0.32 |
| Sodium carbonate | 4.32 |
| Sodium sulphate | 47.49 |
| Soap | 0.78 |
| Water | 24.29 |
| Miscellaneous | 0.42 |
| Total Parts | 100.00 |

¹ A copolymer or any mixture of copolymers according to any of Application Examples 1, 2, 3, 4, 5, 6, 7, 8, 9, 10, 11, 12 or 13.

### Preparation of a Spray-Dried Powder.

An aqueous slurry having the composition as described above is prepared having a moisture content of 25.89%. The aqueous slurry is heated to 72° C. and pumped under high pressure (from 5.5×10⁶Nm⁻² to 6.0×10⁶Nm⁻²), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust the exhaust air in the spray-drying tower and collected in a post tower containment system. The spray-dried powder has a moisture content of 1.0 wt %, a bulk density of 427 g/l and a particle size distribution such that 95.2 wt % of the spray-dried powder has a particle size of from 150 to 710 micrometers. The composition of the spray-dried powder is given below.

### Spray-Dried Powder Composition.

| | % w/w Spray- |
|---|---|
| Component | dried powder |
| A compound having the following general | 1.62 |
| structure: bis((C₂H₅O)(C₂H₄O)n)(CH₃)—N⁺— | |
| CₓH₂ₓ—N⁺—(CH₃)—bis((C₂H₅O)(C₂H₄O)n), | |
| wherein n = from 20 to 30, and x = from 3 to 8, | |
| or sulphated or sulphonated variants thereof | |
| Ethylenediamine disuccinic acid | 0.46 |
| Brightener | 0.16 |
| Magnesium sulphate | 0.95 |
| Acrylate/maleate copolymer | 8.45 |
| Copolymer ¹ | 2.09 |
| Linear alkyl benzene sulphonate | 15.65 |
| Hydroxyethane di(methylene phosphonic acid) | 0.42 |
| Sodium carbonate | 5.65 |
| Sodium sulphate | 61.98 |
| Soap | 1.02 |
| Water | 1.00 |
| Miscellaneous | 0.55 |
| Total Parts | 100.00 |

¹ A copolymer or any mixture of copolymers according to any of Application Examples 1, 2, 3, 4, 5, 6, 7, 8, 9, 10, 11, 12 or 13.

### Preparation of an Anionic Surfactant Particle 1

The anionic detersive surfactant particle 1 is made on a 520 g batch basis using a Tilt-A-Pin then Tilt-A-Plow mixer (both made by Processall). 108 g sodium sulphate supplied is added to the Tilt-A-Pin mixer along with 244 g sodium carbonate. 168 g of 70% active C₂₅E₃S paste (sodium ethoxy sulphate based on C_{12/15} alcohol and ethylene oxide) is added to the Tilt-A-Pin mixer. The components are then mixed at 1200 rpm for 10 seconds. The resulting powder is then transferred into a Tilt-A-Plow mixer and mixed at 200 rpm for 2 minutes to form particles. The particles are then dried in a fluid bed dryer at a rate of 25001/min at 120° C. until the equilibrium relative humidity of the particles is less than 15%. The dried particles are then sieved and the fraction through 1180 μm and on 250 μm is retained The composition of the anionic detersive surfactant particle 1 is as follows:

25.0% w/w C₂₅E₃S sodium ethoxy sulphate
18.0% w/w sodium sulphate
57.0% w/w sodium carbonate

### Preparation of a Cationic Detersive Surfactant Particle 1

The cationic surfactant particle 1 is made on a 14.6 kg batch basis on a Morton FM-50 Loedige mixer. 4.5 kg of micronised sodium sulphate and 4.5 kg micronised sodium carbonate are premixed in the Morton FM-50 Loedige mixer. 4.6 kg of 40% active mono-C₁₂₋₁₄ alkyl mono-hydroxyethyl di-methyl quaternary ammonium chloride (cationic surfactant) aqueous solution is added to the Morton FM-50 Loedige mixer whilst both the main drive and the chopper are operating. After approximately two minutes of mixing, a 1.0 kg 1:1 weight ratio mix of micronised sodium sulphate and micronised sodium carbonate is added to the mixer. The resulting agglomerate is collected and dried using a fluid bed dryer on a basis of 25001/min air at 100-140° C. for 30 minutes. The resulting powder is sieved and the fraction through 1400 μm is collected as the cationic surfactant particle 1. The composition of the cationic surfactant particle 1 is as follows:

15% w/w mono-C₁₂₋₁₄ alkyl mono-hydroxyethyl di-methyl quaternary ammonium chloride
40.76% w/w sodium carbonate
40.76% w/w sodium sulphate
3.48% w/w moisture and miscellaneous

### Preparation of a Granular Laundry Detergent Composition

10.84 kg of the spray-dried powder of example 6, 4.76 kg of the anionic detersive surfactant particle 1, 1.57 kg of the cationic detersive surfactant particle 1 and 7.83 kg (total amount) of other individually dosed dry-added material are dosed into a lm diameter concrete batch mixer operating at 24 rpm. Once all of the materials are dosed into the mixer, the mixture is mixed for 5 minutes to form a granular laundry detergent composition. The formulation of the granular laundry detergent composition is described below:

### A Granular Laundry Detergent Composition.

| | % w/w granular |
|---|---|
| | laundry detergent |
| Component | composition |
| Spray-dried powder from earlier table in Example 5 | 43.34 |
| 91.6 wt % active linear alkyl benzene sulphonate | 0.22 |
| flake supplied by Stepan under the tradename | |
| Nacconol 90G ® | |
| Citric acid | 5.00 |
| Sodium percarbonate (having from 12% to 15% | 14.70 |
| active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate | 4.35 |
| (92 wt % active) | |
| Suds suppressor agglomerate (11.5 wt % active) | 0.87 |
| Acrylate/maleate copolymer particle | 0.29 |
| (95.7 wt % active) | |
| Green/Blue carbonate speckle | 0.50 |
| Anionic detersive surfactant particle 1 | 19.04 |
| Cationic detersive surfactant particle 1 | 6.27 |
| Sodium sulphate | 3.32 |
| Solid perfume particle | 0.63 |
| Total Parts | 100.00 |

### Liquid Laundry Detergents Example 12

| | A | B | C | D | E |
|---|---|---|---|---|---|
| Ingredient | wt % | wt % | wt % | wt % | wt % |
| Sodium alkyl ether sulfate | 14.4% | | 9.2% | 5.4% | |
| Linear alkylbenzene sulfonic | 4.4% | 12.2% | 5.7% | 1.3% | |
| acid | | | | | |
| Alkyl ethoxylate | 2.2% | 8.8% | 8.1% | 3.4% | |
| Amine oxide | 0.7% | 1.5% | | | |
| Citric acid | 2.0% | 3.4% | 1.9% | 1.0% | 1.6% |
| Fatty acid | 3.0% | 8.3% | | | 16.0% |
| Protease | 1.0% | 0.7% | 1.0% | | 2.5% |
| Amylase | 0.2% | 0.2% | | | 0.3% |
| Borax | 1.5% | 2.4% | 2.9% | | |
| Calcium and sodium formate | 0.2% | | | | |
| Formic acid | | | | | 1.1% |
| Copolymer¹ | 1.8% | 2.1% | | | 3.2% |
| Sodium polyacrylate | | | | 0.2% | |
| Sodium polyacrylate | | | 0.6% | | |
| copolymer | | | | | |
| Fluorescent whitening agent | 0.15% | 0.2% | 0.12% | 0.12% | 0.2% |
| Ethanol | 2.5% | 1.4% | 1.5% | | |
| Propanediol | 6.6% | 4.9% | 4.0% | | 15.7% |
| Sorbitol | | | 4.0% | | |
| Ethanolamine | 1.5% | 0.8% | 0.1% | | 11.0% |
| Sodium hydroxide | 3.0% | 4.9% | 1.9% | 1.0% | |
| Sodium cumene sulfonate | | 2.0% | | | |
| Silicone suds suppressor | | 0.01% | | | |
| Perfume | 0.3% | 0.7% | 0.3% | 0.4% | 0.6% |
| Opacifier⁵ | | 0.30% | 0.20% | | 0.50% |
| Water | balance | balance | balance | balance | balance |
| | 100.0% | 100.0% | 100.0% | 100.0% | 100.0% |

¹A copolymer or any mixture of copolymers according to any of Application Examples 1, 2, 3, 4, 5, 6, 7, 8, 9, 10, 11, 12 or 13.
²diethylenetriaminepentaacetic acid, sodium salt
³diethylenetriaminepentakismethylenephosphonic acid, sodium salt
⁴ethylenediaminetetraacetic acid, sodium salt
⁵Acusol OP 301

| | F | G | H | I | J | K |
|---|---|---|---|---|---|---|
| Ingredient | wt % | wt % | wt % | wt % | wt % | wt % |
| Alkylbenzene sulfonic | 7 | 7 | 4.5 | 1.2 | 1.5 | 12.5 |
| acid | | | | | | |
| Sodium C12-14 alkyl | 2.3 | 2.3 | 4.5 | 4.5 | 7 | 18 |
| ethoxy 3 sulfate | | | | | | |
| C14-15 alkyl | 5 | 5 | 2.5 | 2.6 | 4.5 | 4 |
| 8-ethoxylate | | | | | | |
| C12 alkyl dimethyl | — | 2 | — | — | — | — |
| amine oxide | | | | | | |
| C12-14 alkyl | — | — | — | 0.5 | — | — |
| hydroxyethyl | | | | | | |
| dimethyl ammonium | | | | | | |
| chloride | | | | | | |
| C12-18 Fatty acid | 2.6 | 3 | 4 | 2.6 | 2.8 | 11 |
| Citric acid | 2.6 | 2 | 1.5 | 2 | 2.5 | 3.5 |
| Protease enzyme | 0.5 | 0.5 | 0.6 | 0.3 | 0.5 | 2 |
| Amylase enzyme | 0.1 | 0.1 | 0.15 | — | 0.05 | 0.5 |
| Mannanase enzyme | 0.05 | — | 0.05 | — | — | 0.1 |
| Copolymer¹ | 1.0 | .8 | 1 | 0.4 | 1.5 | 2.7 |
| Hydroxyethane | — | — | 0.45 | — | — | 1.5 |
| diphosphonic acid | | | | | | |
| FWA | 0.1 | 0.1 | 0.1 | — | — | 0.2 |
| Solvents (1,2 | 3 | 4 | 1.5 | 1.5 | 2 | 4.3 |
| propanediol, | | | | | | |
| ethanol), stabilizers | | | | | | |
| Hydrogenated castor oil | 0.4 | 0.3 | 0.3 | 0.1 | 0.3 | — |
| derivative structurant | | | | | | |
| Boric acid | 1.5 | 2 | 2 | 1.5 | 1.5 | 0.5 |
| Na formate | — | — | — | 1 | — | — |
| Reversible protease | — | — | 0.002 | — | — | — |
| inhibitor³ | | | | | | |
| Perfume | 0.5 | 0.7 | 0.5 | 0.5 | 0.8 | 1.5 |

| | |
|---|---|
| Buffers (sodium | To pH 8.2 |
| hydroxide, | |
| Monoethanolamine) | |
| Water and minors | To 100 |
| (antifoam, | |
| aesthetics, . . . ) | |

¹The copolymer or any mixture of copolymers according to any of Application Examples 1, 2, 3, 4, 5, 6, 7, 8, 9, 10, 11, 12 or 13.

| | L | M | N | O | P | Q |
|---|---|---|---|---|---|---|
| Ingredient | wt % | wt % | wt % | wt % | wt % | wt % |
| Alkylbenzene sulfonic acid | 5.5 | 2.7 | 2.2 | 12.2 | 5.2 | 5.2 |
| Sodium C12-14 alkyl | 16.5 | 20 | 9.5 | 7.7 | 1.8 | 1.8 |
| ethoxy 3 sulfate | | | | | | |
| Sodium C12-14 alkyl sulfate | 8.9 | 6.5 | 2.9 | — | | |
| C12-14 alkyl 7-ethoxylate | | | | | 0.15 | 0.15 |
| C14-15 alkyl 8-ethoxylate | | | | | 3.5 | 3.5 |
| C12-15 alkyl 9-ethoxylate | 1.7 | 0.8 | 0.3 | 18.1 | — | — |
| C12-18 Fatty acid | 2.2 | 2.0 | — | 1.3 | 2.6 | 2.6 |
| Citric acid | 3.5 | 3.8 | 2.2 | 2.4 | 2.5 | 2.5 |
| Protease enzyme | 1.7 | 1.4 | 0.4 | — | 0.5 | 0.5 |
| Amylase enzyme | 0.4 | 0.3 | — | — | 0.1 | 0.1 |
| Mannanase enzyme | | | | | 0.04 | 0.04 |
| Copolymer¹ | 2.1 | 1.2 | 1.0 | 2 | 1.00 | 0.25 |
| PEG-PVAc Polymer² | — | — | — | — | — | 0.3 |
| Ethoxysulfated | — | — | — | — | — | 0.7 |
| Hexamethylene Diamine | | | | | | |
| Dimethyl Quat | | | | | | |
| FWA | — | — | — | — | .04 | .04 |
| Solvents (1,2 propanediol, | 7 | 7.2 | 3.6 | 3.7 | 1.9 | 1.9 |
| ethanol, stabilizers | | | | | | |
| Hydrogenated castor oil | 0.3 | 0.2 | 0.2 | 0.2 | 0.35 | 0.35 |
| derivative structurant | | | | | | |
| Polyacrylate | — | — | — | 0.1 | — | — |
| Polyacrylate copolymer³ | — | — | — | 0.5 | — | — |
| Sodium carbonate | — | — | — | 0.3 | — | — |
| Sodium silicate | — | — | — | — | — | — |
| Borax | 3 | 3 | 2 | 1.3 | — | — |
| Boric acid | 1.5 | 2 | 2 | 1.5 | 1.5 | 1.5 |
| Perfume | 0.5 | 0.5 | 0.5 | 0.8 | 0.5 | 0.5 |
| Buffers (sodium hydroxide, | | | | | 3.3 | 3.3 |
| monoethanolamine) | | | | | | |

| | |
|---|---|
| Water, dyes and | Balance |
| miscellaneous | |

¹Copolymer or any mixture of copolymers according to any of Application Examples 1, 2, 3, 4, 5, 6, 7, 8, 9, 10, 11, 12 or 13.
²PEG-PVA graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
³Alco 725 (styrene/acrylate)

### Liquid Dish Handwashing Detergents Example 13

| Composition | A | B |
|---|---|---|
| C₁₂₋₁₃ Natural AE0.6S | 29.0 | 29.0 |
| C₁₀₋₁₄ mid-branched Amine Oxide | — | 6.0 |
| C₁₂₋₁₄ Linear Amine Oxide | 6.0 | — |
| SAFOL ® 23 Amine Oxide | 1.0 | 1.0 |
| C₁₁E₉ Nonionic² | 2.0 | 2.0 |
| Ethanol | 4.5 | 4.5 |
| Copolymer¹ | 5.0 | 2.0 |
| Sodium cumene sulfonate | 1.6 | 1.6 |
| Polypropylene glycol 2000 | 0.8 | 0.8 |
| NaCl | 0.8 | 0.8 |
| 1,3 BAC Diamine³ | 0.5 | 0.5 |
| Suds boosting polymer⁴ | 0.2 | 0.2 |
| Water | Balance | Balance |

¹A copolymer or any mixture of polymers according to any of Application Examples 1, 2, 3, 4, 5, 6, 7, 8, 9, 10, 11, 12 or 13.
²Nonionic may be either C₁₁ Alkyl ethoxylated surfactant containing 9 ethoxy groups.
³1,3, BAC is 1,3 bis(methylamine)-cyclohexane.
⁴(N,N-dimethylamino)ethyl methacrylate homopolymer

### Automatic Dishwasher Detergents Example 14

| | A | B | C | D | E | F | G |
|---|---|---|---|---|---|---|---|
| Sodium | 0 | 6 | 10 | 0-20 | 0 | 0 | 0 |
| tripolyphosphate | | | | | | | |
| Silicate solids | 6 | 6 | 6 | 6-10 | 1.5-2.5 | 2.5-6 | 2.5-6 |
| Carbonate | 35 | 40 | 40 | 25-40 | | 25-40 | 25-40 |
| Sodium Bicarbonate | | | | | 5-15 | | |
| Xanthan gum | | | | | 0.5-1.0 | | |
| MGDA | | | | | 4.0-7.5 | 4-7 | 2-4 |
| HEDP | | | | | | 0.05-0.3 | 0.05-0.3 |
| Nonionic surfactant¹ | 0 | 0 | 0 | 0.5-5 | 0.5-5 | 0.5-1.0 | 0.5-1.0 |
| Polymer dispersant² | 0.5 | 5 | 6 | 5 | | 0.1-2.0 | 0.1-2.0 |
| Polymer dispersant³ | | | | | 0.5-3.0 | | |
| Copolymer⁴ | 0.05-10 | 1 | 2.5 | 5 | 6-8 | 4-6 | 2-3 |
| Enzymes | 0.3-0.8 | 0.3-0.8 | 0.3-0.8 | 0.3-0.8 | 0.5-1.0 | 0.25-0.6 | 0.25-0.6 |
| Bleach and bleach | 4 | 4 | 4 | 4 | 0 | 2.0-4.0 | 2.0-4.0 |
| activators | | | | | | | |
| Disodium citrate | 0 | 0 | 0 | 2-20 | 0 | 0 | 0 |
| dihydrate | | | | | | | |
| Sodium Sulfate | 30-50 | 30-50 | 30-50 | 30-50 | 0 | 30-50 | 30-50 |
| Perfume | 0.01-0.1 | 0.01-0.1 | 0.01-0.1 | 0.01-0.1 | 0.01-0.1 | 0.01-0.1 | 0.01-0.1 |
| Water, dye and other | Balance | Balance | Balance | Balance | Balance | Balance | Balance |
| adjuncts | to 100% | to 100% | to 100% | to 100% | to 100% | to 100% | to 100% |

¹Such as SLF-18 POLY TERGENT from the BASF Corporation.
²Copolymer such as ACUSOL ® 445N from Rohm & Haas or ALCOSPERSE ® 725 from Alco.
³Ethoxylated cationic diame such as those disclosed in U.S. Pat. No. 4,659,802.
⁴A copolymer or any mixture of copolymers according to any of Application Examples 1, 2, 3, 4, 5, 6, 7, 8, 9, 10, 11, 12 or 13.

### Automatic Dishwashing Unit-Dose Products Example 15

| Example | A |
|---|---|
| Particulate composition | |
| STPP | 0 |
| Silicate | 2-8 |
| Carbonate | 25-50 |
| Copolymer¹ | 5-10 |
| Polymer Dispersant² | 1-5 |
| Nonionic Surfactant³ | 1-5 |
| Enzyme | 1-6 |
| Bleach and Bleach | 2.5-10 |
| Activators | |
| Perfume | 0.05-1 |
| Sodium Sulfate | 0-10 |
| Liquid composition | |
| DPG | 40-50 |
| Nonionic Surfactant³ | 40-50 |
| Neodol C11E9 | 0-5.0 |
| Glycerine | 0-5.0 |
| Dye | 0.1-1.0 |

¹A copolymer or any mixture of copolymers according to any of Application Examples 1, 2, 3, 4, 5, 6, 7, 8, 9, 10, 11, 12 or 13.
²Copolymer such as ACUSOL ® 445N from Rohm & Haas or ALCOSPERSE ® 725 from Alco.
³Such as SLF-18 POLY TERGENT from the BASF Corporation.

1. A laundry detergent or cleaning composition which comprises a polymer composition containing a polymer obtained by polymerizing a polyoxyalkylene-based compound and an unsaturated monomer containing an acid group in the presence of a polymerization initiator, which is characterized by that the polyoxyalkylene-based compound includes
1) a group containing a carbon-carbon double bond,
2) a polyalkylene glycol chain, and
3) one of the groups shown in formulas (1)-(5), and the amount of solvent used at the time of the polymerization is 10 parts or less for
100 parts of the polyoxyalkylene-based compound. 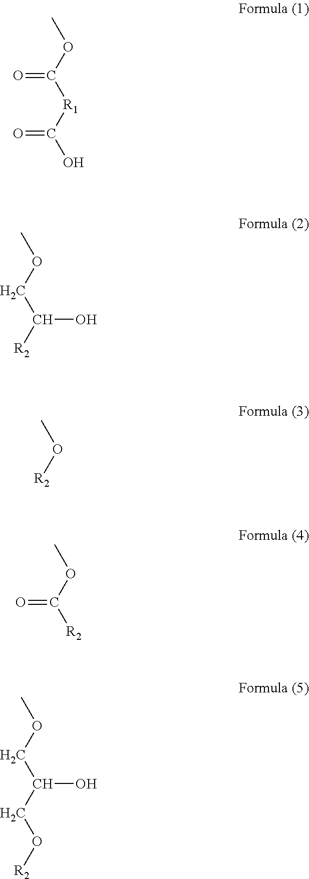
in the formulas (1), R₁ is an alkylene group with 8-20 carbon atoms or an aromatic group with 6-20 carbon atoms, and in the formulas (2)-(5), R₂ is an aryl group with 6-20 carbon atoms or an alkyl group with 8-20 carbon atoms or an alkenyl group with 8-20 carbon atoms.

2. A laundry detergent or cleaning composition according to claim 1 wherein the laundry detergent or cleaning composition is selected from the group consisting of liquid laundry detergent compositions, solid laundry detergent compositions, hard surface cleaning compositions, liquid hand dishwashing compositions, solid automatic dishwashing compositions, liquid automatic dishwashing compositions, and tab/unit dose form automatic dishwashing compositions.

3. A laundry detergent or cleaning composition according to claim 1 wherein the detergent or cleaning composition comprises from about 1% to about 20% by weight of the hydrophobic group-containing copolymer composition.

4. A laundry detergent or cleaning composition according to claim 1 wherein the detergent or composition further comprises a surfactant system.

5. A laundry detergent or cleaning composition according to claim 4 wherein the surfactant system comprises C₁₀-C₁₅ alkyl benzene sulfonate.

6. A laundry detergent or cleaning composition according to claim 4 wherein the surfactant system comprises C₈-C₁₈ linear alkyl sulfonate surfactant.

7. A laundry detergent or cleaning composition according claim 4 wherein the surfactant system further comprises one or more co-surfactants selected from the group consisting of nonionic surfactants, cationic surfactants, anionic surfactants, and mixtures thereof.

8. A laundry detergent or cleaning composition according to claim 1 wherein the detergent or composition further comprises cleaning adjunct additives selected from the group consisting of, enzymes, alkali builders, chelant builders, bleaches, bleaching assisting agents, perfumes, defoaming agents, bactericides, corrosion inhibitors, and mixtures thereof.

9. A cleaning implement comprising a nonwoven substrate and the laundry detergent or cleaning composition according to claim 1.
